(19) United States
(12) Patent Application Publication
(10) Pub. No.: US 2026/0034893 A1
(43) Pub. Date: Feb. 5, 2026

(54) LINEAR TRANSPORT SYSTEM

(71) Applicant: Beckhoff Automation GmbH, Verl (DE)

(72) Inventors: Uwe Prüssmeier, Lemgo (DE); Armin Pehlivan, Nüziders (AT); Frank Würthner, Dauchingen (DE); Thomas Morscher-Unger, Wien (AT); Ray Böhnke, Verl (DE); Peter Kastler, Wien (AT)

(21) Appl. No.: 19/357,179

(22) Filed: Oct. 14, 2025

Related U.S. Application Data
(63) Continuation of application No. PCT/EP2024/060729, filed on Apr. 19, 2024.

(30) Foreign Application Priority Data
Apr. 25, 2023 (DE) 10 2023 110 521.3

(51) Int. Cl. B60L 13/03; B60L 13/00; B65G 21/10; B65G 47/64; B65G 54/02

(52) U.S. Cl. CPC B60L 13/03; B60L 13/003; B65G 21/10; B65G 47/641; B65G 47/644; B65G 54/02; B60L 2200/26; B65G 2207/30

(57) ABSTRACT

A linear transport system includes a movable unit, a guide rail for guiding the movable unit, and a linear motor for driving the movable unit along the guide rail. The linear transport system also includes at least one switch having at least one static retraction element with a retraction motor module and a retraction rail element, and at least two static extension elements, each with an extension motor module and an extension rail element. The switch includes an exchange device having at least two exchange elements, each with an exchange motor module and an exchange rail element. In a first position of the exchange device, the retraction element is connected to a first extension element via a first exchange element. In a second position, the retraction element is connected to a second extension element via a second exchange element.

### CROSS-REFERENCE TO RELATED APPLICATIONS

This patent application is a continuation of International Patent Application No. PCT/EP2024/060729, filed Apr. 19, 2024, entitled “Linear Transport System,” which claims the priority of German patent application DE 10 2023 110 521.3, filed Apr. 25, 2023, entitled “Lineares Transportsystem,” each of which is incorporated by reference herein, in the entirety and for all purposes.

### FIELD

Linear transport systems are known from the state of the art. For example, DE 10 2014 100 636 A1 describes a linear transport system having a movable unit, a guide rail for guiding the movable unit and a linear motor for driving the movable unit along the guide rail, wherein the linear motor comprises a stator and a rotor, wherein the stator comprises a plurality of motor modules arranged in a stationary manner along the guide rail, each of which comprises a plurality of drive coils, wherein the rotor is arranged on the movable unit and comprises a plurality of magnets. Such linear transport systems may be used, for example, in automation technology and/or production technology and transport products to be processed.

A linear transport system of this type particularly comprises a continuous, i.e. self-contained, guide rail. This allows the moving units to be moved along a closed path. In such linear transport systems, a product to be processed is always guided along a predetermined path. Further approaches for providing more flexible linear transport systems are also known from the state of the art. EP 3 109 998 A1, for example, discloses a linear transport system in which a movable unit may be transferred from one partial system to another partial system. However, the method disclosed in EP 3 109 998 A1 limits the possibilities of how an object may be arranged on the movable units, i.e. how the movable unit carries and transports the object, as the movable units have to be configured in such a way that they are each arranged on one of two long stator linear motors with two different sides, respectively. This means that objects can only be arranged above or below the long stator linear motors.

### SUMMARY

According to a first aspect, a linear transport system comprises a movable unit, a guide rail for guiding the movable unit as well as a linear motor for driving the movable unit along the guide rail, wherein the linear motor comprises a stator and a rotor, wherein the stator comprises a plurality of motor modules which are arranged in a stationary manner along the guide rail and each comprise a plurality of drive coils, wherein the rotor is arranged on the movable unit and comprises a plurality of magnets, wherein the guide rail is arranged on the motor modules. The linear transport system further comprises at least one switch, wherein the switch comprises at least one static retraction element with a retraction motor module and a retraction rail element belonging to the guide rail, at least two static extension elements, each having an extension motor module and an extension rail element belonging to the guide rail, and an exchange device, wherein the exchange device comprises at least two exchange elements, each having an exchange motor module and an exchange rail element belonging to the guide rail, wherein, in a first position of the exchange device, the retraction element is connected to a first extension element via a first exchange element and, in a second position of the exchange device, the retraction element is connected to a second extension element via a second exchange element.

According to a second aspect, a method operates a linear transport system. The linear transport system comprises a movable unit, a guide rail for guiding the movable unit as well as a linear motor for driving the movable unit along the guide rail, wherein the linear motor comprises a stator and a rotor, wherein the stator comprises a plurality of motor modules which are arranged in a stationary manner along the guide rail and each comprise a plurality of drive coils, wherein the rotor is arranged on the movable unit and comprises a plurality of magnets, wherein the guide rail is arranged on the motor module. The linear transport system further comprises at least one switch, wherein the switch comprises at least one static retraction element with a retraction motor module and a retraction rail element belonging to the guide rail, at least two static extension elements, each having an extension motor module and an extension rail element belonging to the guide rail, and an exchange device, wherein the exchange device comprises at least two exchange elements, each having an exchange motor module and an exchange rail element belonging to the guide rail, wherein, in a first position of the exchange device, the retraction element is connected to a first extension element via a first exchange element and, in a second position of the exchange device, the retraction element is connected to a second extension element via a second exchange element. The method comprises the steps of determining a position of an exchange device of the linear transport system, selecting a control program based on the position, and logically switching drive coils of the linear transport system based on the position.

A switch for a linear transport system comprises at least one static retraction element having a retraction motor module and a retraction rail element belonging to the guide rail, at least two static extension elements having in each case one extension motor module and in each case one extension rail element belonging to the guide rail, and an exchange device, wherein the exchange device comprises at least three exchange elements, each having an exchange motor module and a respective exchange rail element belonging to the guide rail. The switch for a linear transport system further comprises at least one static retraction element with a retraction motor module and a retraction rail element belonging to the guide rail, at least two static extension elements, each having an extension motor module and an extension rail element belonging to the guide rail, and an exchange device. In a first position of the exchange device the retraction element is connected to a first extension element via a first exchange element. In a second position of the exchange device the retraction element is connected to a second extension element via a second exchange element. In a third position of the exchange device the retraction element is connected to a third extension element via a third exchange element.

### Examples

The invention relates to a linear transport system having a movable unit, a guide rail for guiding the movable unit and a linear motor for driving the movable unit along the guide rail. The linear motor comprises a stator and a rotor. The stator comprises a plurality of motor modules arranged in a stationary manner along the guide rail, each of which comprises a plurality of drive coils. The rotor is arranged on the moving unit and comprises a plurality of magnets. The guide rail is arranged on the motor modules. The linear transport system comprises at least one switch. The switch comprises at least one static retraction element with a retraction motor module and a retraction rail element belonging to the guide rail. The switch also comprises at least two static extension elements, each with an extension motor module and an extension rail element belonging to the guide rail. Furthermore, the switch comprises an exchange device. The exchange device comprises at least two exchange elements, each with an exchange motor module and an exchange rail element belonging to the guide rail. In a first position of the exchange device, the retraction element is connected to a first extension element via a first exchange element. In a second position of the exchange device, the retraction element is connected to a second extension element via a second exchange element.

The first exchange element and the second exchange element may be exchanged between the retraction element and the extension elements. In particular, a moving unit may reach the switch via the retraction element and then either reach the first extension element via the first exchange element or the second extension element via the second exchange element. This allows, for example, a product flow to be divided up and different products to be fed to different processing stations. Overall, this results in a significantly more flexible linear transport system.

If more than two extension elements are provided, the number of exchange elements may be adapted to the number of extension elements. If a plurality of retractable elements are provided, as well, a number of exchange elements may correspond to a product of a number of retractable elements and a number of extendable elements.

The invention further relates to a method for operating such a linear transport system. In this method, a position of an exchange device of the linear transport system, i.e. in particular a switch of the linear transport system, is first determined. A control program is then selected based on the position. Furthermore, a logical switching of drive coils of the linear transport system takes place based on the determined position. This method may be carried out in particular by a controller of the linear transport system.

The invention also relates to a switch for a linear transport system. The switch comprises at least one static retraction element with a retraction motor module and a retraction rail element belonging to the guide rail. The switch also comprises at least two static extension elements, each with an extension motor module and an extension rail element belonging to the guide rail. Furthermore, the switch comprises an exchange device. The exchange device comprises at least two exchange elements, each with an exchange motor module and an exchange rail element belonging to the guide rail. In a first position of the exchange device, the retraction element is connected to a first extension element via a first exchange element. In a second position of the exchange device, the retraction element is connected to a second extension element via a second exchange element.

It is possible that the linear transport system contains more than one such switch. In this case, it may be provided that a further switch contains a plurality of retraction elements and possibly only one extension element. In this way, a product flow that has been split up with the aid of the switch may be reunited with the aid of the additional switch.

In an embodiment of the linear transport system or of the switch, the exchange device comprises a movable switch element. The first exchange element is permanently connected to the movable switch element. The second exchange element is permanently connected to the movable switch element. In particular, the movable switch element may be used to move the first exchange element or the exchange device into the first position and the second exchange element or the exchange device into the second position.

In an embodiment of the linear transport system or of the switch, the exchange device comprises more than two exchange elements, each with an exchange motor module and an exchange rail element belonging to the guide rail. The switch also comprises a number of static extension elements adapted to the number of exchange elements, each with an extension motor module and an extension rail element belonging to the guide rail. This makes it possible to achieve more than two extension elements with the aid of the switch.

In an embodiment of the linear transport system or of the switch, at least one exchange element is curved. In particular, both exchange elements or more than one exchange element may also be curved. This allows the switch or the linear transport system to be made even more flexible.

The exchange element consists of at least the exchange rail element and the exchange motor module. The exchange element may be linear. In this case, the exchange rail element may be arranged in a main direction of extension and the exchange motor module may be arranged on the exchange rail element. In particular, the exchange motor module may be arranged in parallel with regard to the exchange rail element. A linear exchange element is not curved. A curved exchange element may comprise an exchange rail element that is curved with at least one curvature having a radius of curvature out of a main direction of extension. The curvature of the exchange rail element may be embodied in such a way that the exchange rail element follows at least one curved line and thus provides a movement path for a movable unit, with the aid of which the movable unit is guided in such a way that the movable unit carries out a curved movement. In particular, the movable unit may therefore be moved outside of the main direction of extension. The exchange motor module may also be arranged in parallel with regard to the exchange rail element and follow the curvature of the exchange rail element. A linear exchange rail element therefore allows the movable unit to move along a straight line, while a curved exchange element allows the movable unit to move along a curved path.

In an embodiment of the linear transport system or of the switch, the linear transport system or the switch comprises a primary plane. The primary plane is spanned by the retraction motor module and the retraction rail element. A first extension plane is perpendicular with regard to the primary plane and is guided by the extension rail element of the first extension element. The extension rail element of the second extension element also lies in the first extension plane.

In an embodiment of the linear transport system or of the switch, the linear transport system comprises a primary plane. The primary plane is spanned by the retraction motor module and the retraction rail element. A first extension plane is perpendicular to the primary plane and is guided by the extension rail element of the first extension element. The extension rail element of the second extension element lies at least partially in a second extension plane, wherein the second extension plane is parallel to the first extension plane and is arranged at a distance from the first extension plane. In this embodiment, extension elements are therefore provided in different planes.

In an embodiment of the linear transport system or of the switch, the exchange device comprises a drive. The drive may be used to move the exchange device into the first position and into the second position. In particular, the drive may drive the movable switch element.

In an embodiment of the linear transport system or of the switch, the first exchange element and the second exchange element are arranged on a rotatable body. Rotation of the rotatable body may be triggered with the aid of the drive. The rotatable body may be part of the movable switch element.

In an embodiment of the linear transport system or of the switch, the first exchange element and the second exchange element are arranged on a displaceable plate. A displacement of the displaceable plate may be triggered with the aid of the drive. The displaceable plate may be part of the movable switch element.

In an embodiment of the linear transport system or of the switch, in the first position the retraction motor module is flush with the exchange motor module of the first exchange element and the exchange motor module of the first exchange element is flush with the extension motor module of the first extension element. In the second position, the retraction motor module is flush with the exchange motor module of the second exchange element and the exchange motor module of the second exchange element is flush with the extension motor module of the second extension element. In this way, a simple transition of the movable unit may be achieved.

In an embodiment of the linear transport system or of the switch, a retraction gap with a predefined retraction gap width is arranged in the first position between the retraction motor module and the exchange motor module of the first exchange element. In particular, the retraction gap width may be smaller than a coil distance between two drive coils of the motor modules.

In an embodiment of the linear transport system or of the switch, an extension gap with a predetermined extension gap width is arranged in the first position between the exchange motor module of the first exchange element and the extension motor module of the first extension element. In particular, the extension gap width may be smaller than a coil distance between two drive coils of the motor modules.

In an embodiment of the linear transport system or of the switch, the drive coils are arranged within the motor modules in such a way that two drive coils have a predetermined distance with regard to each other. A drive coil arranged at the rear in the direction of travel in the retraction motor module and a drive coil arranged at the front in the direction of travel in the exchange motor module of the first exchange element also have the predetermined distance when the exchange device is arranged in the first position. The drive coil arranged at the rear in the direction of travel in the retractoin motor module and a drive coil arranged at the front in the direction of travel in the exchange motor module of the second exchange element also have the specified distance when the exchange device is arranged in the second position. With this embodiment, an identical drive coil distance may be achieved between the single drive motor module and the exchange motor modules. This drive coil distance may correspond to the drive coil distance generally present in the motor modules.

In an embodiment of the linear transport system or of the switch, a drive coil arranged at the rear in the direction of travel in the exchange motor module of the first exchange element and a drive coil arranged at the front in the direction of travel in the extension motor module of the first extension element also have the predetermined distance when the exchange device is arranged in the first position. A drive coil arranged at the rear in the direction of travel in the exchange motor module of the second exchange element and a drive coil arranged at the front in the direction of travel in the extension motor module of the second extension element also have the specified distance when the exchange device is arranged in the second position. With this embodiment, an identical drive coil distance may be achieved between the exchange motor modules and the extension motor modules. This drive coil distance may correspond to the drive coil distance generally present in the motor modules.

In an embodiment of the linear transport system, said linear transport system also comprises a controller. The controller is set up to select a control program on the basis of a position of the exchange device and to carry out a logical switching of drive coils on the basis of the position of the exchange device. In particular, the controller may also be set up to carry out the method according to the invention. In addition, it may be provided that the controller generally controls all motor modules or all drive coils of the motor modules.

In an embodiment of the linear transport system, the controller is set up to determine a position of the movable unit with the aid of position detectors arranged within the motor modules and to select the drive coils to be actuated for driving the movable unit on the basis of the position of the movable unit and a position of the exchange device and to initiate energization of these drive coils to be actuated.

In an embodiment of the linear transport system, the controller is also set up to logically advance position detectors based on the position of the exchange device. In particular, the logical switching of the position detectors may involve the position detectors being switched logically from the retraction motor module via the exchange motor module of the first exchange element to the extension motor module of the first extension element in the first position and from the retraction motor module via the exchange motor module of the second exchange element to the extension motor module of the second extension element in the second position. This allows for continuous position detection of the moving unit as it passes through the switch.

In the first position of the exchange device, it may be provided that the position detectors of the exchange motor module of the second exchange element are deactivated. In the second position of the exchange device, it may be provided that the position detectors of the exchange motor module of the first exchange element are deactivated. Alternatively, however, it is also possible to leave these position detectors activated, for example if movable units are arranged on the corresponding exchange elements. In this way, for example, movable units may be arranged on those exchange elements that are no longer connected to the retraction element and/or to one of the extension elements. However, in order to be able to control the holding and/or positioning of the movable unit on such an exchange element, the associated position detectors may remain activated.

In an embodiment of the linear transport system, the controller is set up to check whether the exchange device is in the first position or in the second position or in an intermediate position. The controller is also set up to prevent the drive coils of the exchange motor module of the second exchange element and the extension motor module of the second extension element from being energized in the first position. The controller is also set up to prevent the drive coils of the exchange motor module of the first exchange element and the extension motor module of the first extension element from being energized in the second position. The controller is also set up to prevent the drive coils of the retraction motor module of the retraction element, the exchange motor module of the first exchange element, the extension motor module of the first extension element, the exchange motor module of the second exchange element and the extension motor module of the second extension element from being energized in the intermediate position. In this way, safe operation of the linear transport system may be achieved.

In an embodiment of the method for operating the linear transport system, a position of the moving unit is also determined with the aid of position detectors arranged within the motor modules. Furthermore, drive coils to be actuated are selected on the basis of the position and the position of the moving unit. In addition, these drive coils to be controlled are energized.

In an embodiment of the method for operating the linear transport system, position detectors are logically switched over based on the position of the exchange device. In particular, the logical switching of the position detectors may involve the position detectors being switched logically in the first position from the retraction motor module via the exchange motor module of the first exchange element to the extension motor module of the first extension element and in the second position from the retraction motor module via the exchange motor module of the second exchange element to the extension motor module of the second extension element. This allows for continuous position detection of the moving unit as it passes through the switch.

In the first position of the exchange device, it may be provided that the position detectors of the exchange motor module of the second exchange element are deactivated. In the second position of the exchange device, it may be provided that the position detectors of the exchange motor module of the first exchange element are deactivated. Alternatively, however, it is also possible to leave these position detectors activated, for example if movable units are arranged on the corresponding exchange elements. In this way, for example, movable units may be arranged on those exchange elements that are no longer connected to the retraction element and/or one of the extension elements. However, in order to be able to control the holding and/or positioning of the movable unit on such an exchange element, the associated position detectors may remain activated.

In an embodiment of the method for operating the linear transport system, it is examined whether the exchange device is in the first position or in the second position or in an intermediate position. In the first position, energizing of the drive coils of the exchange motor module of the second exchange element and the extension motor module of the second extension element is prevented. In the second position, energizing of the drive coils of the exchange motor module of the first exchange element and the extension motor module of the first extension element is prevented. In the intermediate position, the drive coils of the retraction motor module of the retraction element, the exchange motor module of the first exchange element, the extension motor module of the first extension element, the exchange motor module of the second exchange element and the extension motor module of the second extension element are prevented from being energized.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows an isometric view of a linear transport system.

FIG. 2 shows a cross-section of the linear transport system of FIG. 1.

FIG. 3 shows an isometric view of a first embodiment of a switch of a linear transport system in a first position.

FIG. 4 shows an isometric view of the switch according to FIG. 3 in a second position.

FIG. 5 shows an isometric view of a second embodiment of a switch of a linear transport system in a first position.

FIG. 6 shows an isometric view of the switch according to FIG. 5 in a second position.

FIG. 7 shows an isometric view of a third embodiment of a switch of a linear transport system in a first position.

FIG. 8 shows an isometric view of the switch according to FIG. 7 in a second position.

FIG. 9 shows an isometric view of the switch according to FIG. 7 in a third position.

FIG. 10 shows an isometric view of the switch according to FIG. 7 in a fourth position.

FIG. 11 shows a side view of the switch as shown in FIG. 10.

FIG. 12 shows an isometric view of the switch according to FIG. 7 in a fifth position.

FIG. 13 shows an isometric view of a fourth embodiment of a switch of a linear transport system in a first position.

FIG. 14 shows an isometric view of the switch according to FIG. 13 in a second position.

FIG. 15 shows an isometric view of the switch according to FIG. 13 in a third position.

FIG. 16 shows an isometric view of the switch according to FIG. 13 in a fourth position.

FIG. 17 shows an isometric view of the switch according to FIG. 13 in a fifth position.

FIG. 18 shows a flow chart of a method for operating a linear transport system.

### DETAILED DESCRIPTION

Identical reference numerals are used for identical elements in the drawings. Furthermore, for reasons of clarity, it may be provided that not all elements are shown in every figure. Furthermore, for this reason, it may also be provided that not every element is assigned its own reference numeral in every drawing.

Terms that describe a spatial arrangement, such as “above”, “below”, “next to”, “to the side”, “horizontal”, “vertical”, “right”, “left”, each refer to the arrangement shown in the figure described. Such terms merely serve to facilitate the comprehensibility of the description and are not to be interpreted restrictively.

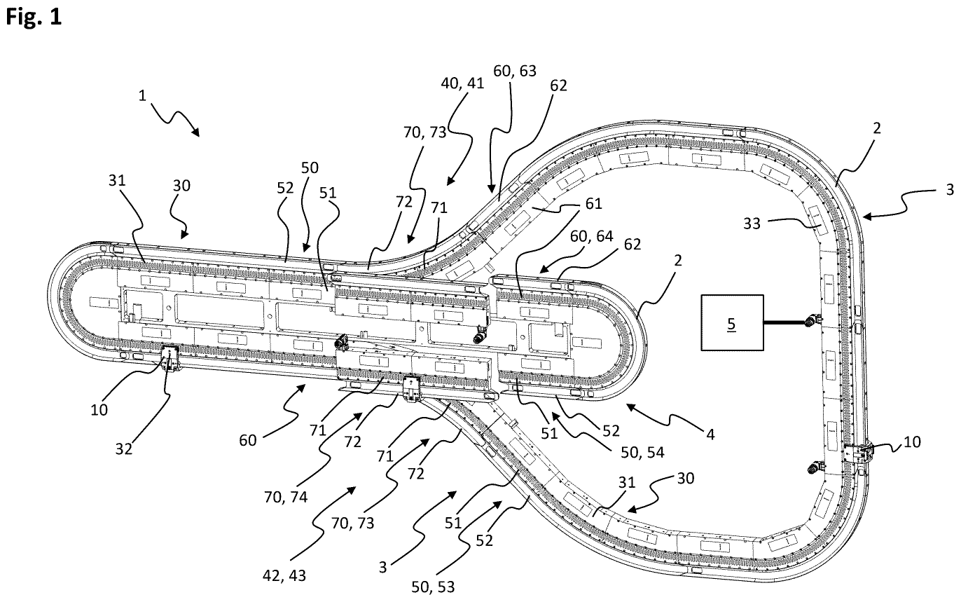

FIG. 1 shows a linear transport system 1 having a movable unit 10, a guide rail 2 for guiding the movable unit 10 and a linear motor 30 for driving the movable unit 10 along the guide rail 2. The linear motor 30 comprises a stator 31 and a rotor 32. The stator 31 comprises a plurality of motor modules 33 arranged in a stationary manner along the guide rail 2. The guide rail 2 is arranged at the motor modules 33. The linear transport system 1 comprises at least one switch 40. The switch 40 comprises at least one static retraction element 50 with a retraction motor module 51 and a retraction rail element 52 belonging to the guide rail 2. The switch 40 also comprises at least two static extension elements 60, each with an extension motor module 61 and an extension rail element 62 belonging to the guide rail 2. Furthermore, the switch 40 comprises an exchange device 41. The exchange device 41 comprises two exchange elements 70, each with an exchange motor module 71 and an exchange rail element 72 belonging to the guide rail 2. In a first position of the exchange device 41, the retraction element 50 is connected to a first extension element 63 via a first exchange element 73. The first position is shown in FIG. 1. In a second position of the exchange device 41, the retraction element 50 is connected to a second extension element 64 via a second exchange element 74.

The first exchange element 73 and the second exchange element 74 may be exchanged between the retraction element 50 and the first extension element 63 or the second extension element 64. In particular, the movable unit 10 may reach the switch 40 via the retraction element 50 and then either reach the first extension element 63 via the first exchange element 73 or the second extension element 64 via the second exchange element 74. This e.g. allows for a product flow to be divided up and different products to be guided to different processing stations. Overall, this results in a significantly more flexible linear transport system 1.

The movable unit 10 may be moved along the guide rail 2. Depending on the position of the exchange device 41, it is possible to move the movable unit 10 into different areas, in particular a first area 3 and a second area 4. In particular, it may be provided that the movable unit 10 is moved clockwise in the linear transport system 1. The linear transport system 1 comprises a closed guide rail 2, so that the movable unit 10 may always be moved back to its starting position. The clockwise movement of the movable unit 10 in the linear transport system 1 may in particular serve to indicate the directions that are used thereafter for the positions of the switch 40 or for the positions of the exchange device 41. Of course, it is also possible to move the movable unit 10 counterclockwise in the linear transport system 1 or even to reverse the direction of movement after braking the movable unit 10. For example, different processing stations may be provided in the first area 3 than in the second area 4.

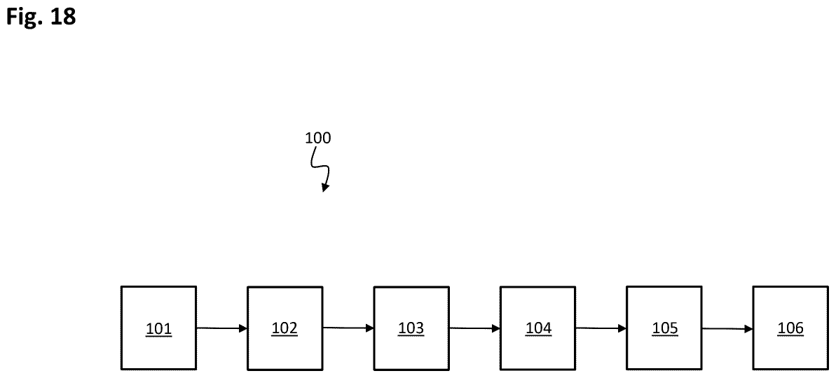

FIG. 1 furthermore shows an optional controller 5. The controller 5 may be set up to control a method for operating the linear transport system 1. For this purpose, the controller 5 may be set up to control the linear motor 30 and trigger a movement of the movable unit 10. Furthermore, the controller 5 may be directed to take over control of the switch 40. Details of the controller 5 or a control method that may be carried out with the controller 5 are described, for example, in connection with FIG. 18.

It may be provided that the controller 5 is connected to all motor modules 30, i.e. in particular also to the exchange motor modules 71 of the first exchange element 73 or the second exchange element 74 and the motor modules 30 of the second area 4, in such a way that data communication between the controller 5 and all motor modules 30 is possible, for example, to send position detector data and/or other sensor and/or system data from the motor modules 30 to the controller 5 and/or to send, for example, control signals for the coils of the motor modules 30 and/or other data from the controller 5 to the motor modules 30. In particular, data communication between the controller 5 and the exchange motor modules 71 of the first exchange element 73 or the second exchange element 74 and the motor modules 30 of the second area 4 is therefore possible without corresponding connections being shown in FIG. 1. The connections may be wired or wireless. It may also be provided that all motor modules 30 are connected to a power supply at all times in order to allow for energizing of the drive coils.

In particular, it may be provided that the exchange motor modules 71 of the first exchange element 73 or of the second exchange element 74 are permanently connected to the controller 5 for the purpose of data exchange and are also permanently supplied with energy, irrespective of a position of the exchange device 41.

The switches described below may also be equipped with corresponding data connections and a corresponding energy supply.

FIG. 1 furthermore shows a further switch 42. The further switch 42 comprises a further exchange device 43. The further switch 42 comprises a plurality of retraction elements, in particular a first retraction element 53 and a second retraction element 54. The first retraction element 53 comprises a retraction motor module 51 and a retraction rail element 52 belonging to the guide rail 2. The second retraction element 54 also comprises a retracting motor module 51 and a retracting rail element 52 belonging to the guide rail 2. The further exchange device 43 comprises two exchange elements 70, each with an exchange motor module 71 and an exchange rail element 72 belonging to the guide rail 2. In a first position of the further exchange device 43, the first retraction element 53 is connected to an extension element 60 via a first exchange element 73. The first position is shown in FIG. 1. In a second position of the further exchange device 43, the second retraction element 54 is connected to the extension element 60 via a second exchange element 74.

The first exchange element 73 and the second exchange element 74 may be exchanged between the first retraction element 53 or the second retraction element 54 and the extension element 60. In particular, the movable unit 10 may reach the further switch 42 either via the first retraction element 53 or via the second retraction element 54 and then reach the extension element 60 either via the first exchange element 73 or via the second exchange element 74. As a result, the product flow divided up with the aid of the switch 40 may be rejoined with the aid of the further switch 42.

It is possible that the movable unit 10 is moved counterclockwise. In this case, the product flow may be divided up via the further switch 42 and rejoined via the switch 40. Furthermore, the switches 40 may be provided with more than one retraction element 50 or further points 42 with more than one extension element 60. The terms retraction element 50 and extension element 60 refer to the direction of travel of the movable unit 10 in the clockwise direction arbitrarily selected in FIG. 1. However, the movable unit 10 may be moved in both directions. Furthermore, more than one movable unit 10 may be provided in the linear transport system 1.

The invention also relates to the switch 40 with the features explained in connection with FIG. 1. The invention also relates to the further switch 42 with the features explained in connection with FIG. 1.

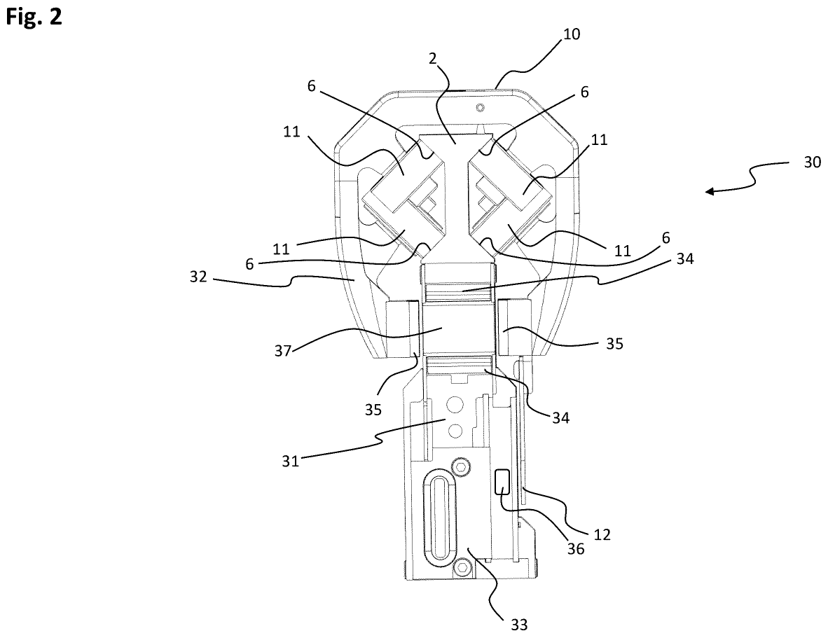

FIG. 2 shows a cross-section through the linear transport system 1, in particular through one of the motor modules 33 and the movable unit 10. For better representation, any sectional surfaces have not been hatched. Drive coils 34 of the stator of the linear motor 30 are arranged within the motor modules 33, each of which is wound around a stator tooth 37. In addition, a further stator tooth 37 may be provided between each two drive coils 34. In particular, a plurality of drive coils 34 may be arranged per motor module. The rotor 32 is arranged on the movable unit 10 and comprises a plurality of magnets 35. The linear motor 30 may be embodied as in the linear transport system 1 marketed by Beckhoff Automation Gmbh & Co KG under the brand name “XTS”. Optionally shown in FIG. 2 is that the guide rail 2 comprises rolling surfaces 6. Rollers 11 of the movable unit 10 may roll on the rolling surfaces 6 and thus guidance of the movable unit 10 along the guide rail 2 may be achieved.

Also shown in FIG. 2 is an optional position detector 36 of the motor module 33. A position of the movable unit 10 may be determined using a signal from the position detector 36. For this purpose, it may be provided that the movable unit 10 comprises a position element 12. The presence of the position element 12 may be detected by the position detector 36. For example, the position element 12 may be a position magnet or another unit that may be detected by the position detector 36. In this case, the position detector 36 may be a magnetic field sensor, for example a Hall sensor. It is also possible to determine a position of the movable unit 10 with the aid of the position detector 36 using a magnetic field of the magnets 35 of the rotor 32. For this purpose, the position detector 36 may be arranged at a different position within the motor module 33.

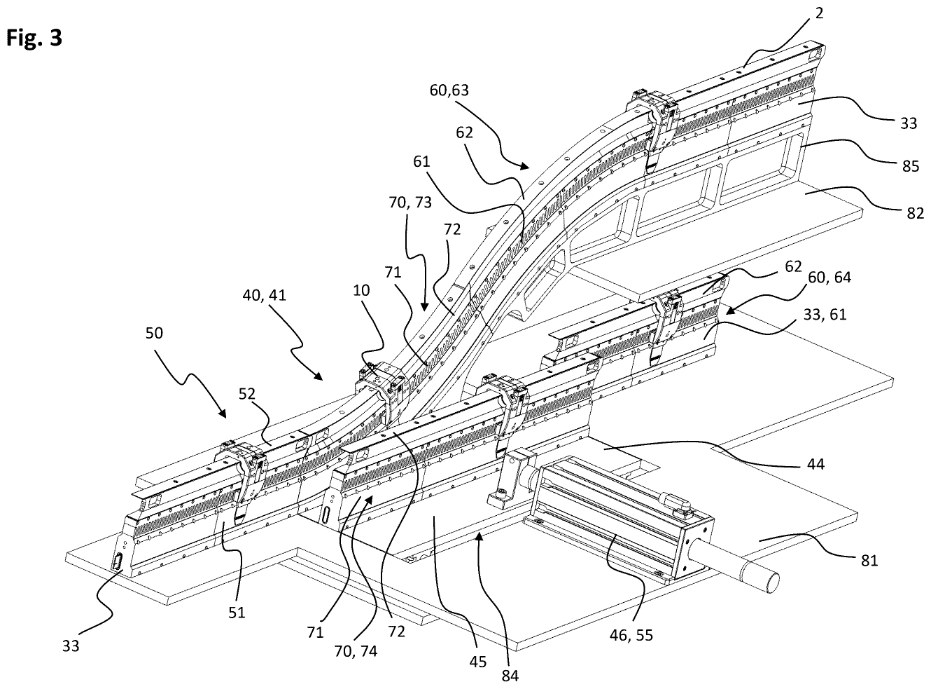

FIG. 3 shows an isometric view of an embodiment of a switch 40 that may be used in the linear transport system 1 of FIGS. 1 and 2. In particular, this switch 40 again comprises the retraction element 50 with the retraction motor module 51 and the retraction rail element 52 as well as the extension elements 60 with the respective extension motor modules 61 and extension rail elements 62. The exchange device 41 comprises a movable switch element 44. In this embodiment example, the movable switch element 44 is optionally embodied as a displaceable plate 45. The first exchange element 73 with the associated exchange motor module 71 and exchange rail element 72 is permanently connected to the movable switch element 44. The second exchange element 74 with the associated exchange motor module 71 and exchange rail element 72 is also permanently connected to the movable switch element 44. In particular, the exchange motor modules 71 of the first exchange element 73 or the second exchange element 74 may be attached to the movable switch element 44. The movable switch element 44 may serve in particular to bring the first exchange element 73 or the exchange device 41 into the first position and the second exchange element 74 or the exchange device 41 into the second position. The first position is shown in FIG. 3. The retraction element 50 is connected to the first extension element 63 via the first exchange element 73.

Furthermore, FIG. 3 shows a movable unit 10 that is being moved over the first exchange element 73.

It may be provided that the controller 5 is permanently connected to all motor modules 30, i.e. in particular also to the exchange motor modules 71 of the first exchange element 73 or the second exchange element 74 and the extension motor modules 61 of the first extension element 63 or the second extension element in such a way that data communication between the controller 5 and all motor modules 30 is possible, for example to send position detector data and/or further sensor and/or system data from the motor modules 30 to the controller 5 and/or to send, for example, actuation signals for the coils of the motor modules 30 and/or further data from the controller 5 to the motor modules 30. In particular, data communication between the controller 5 and the exchange motor modules 71 of the first exchange element 73 or the second exchange element 74 is therefore possible without corresponding connections being shown in FIG. 3. The connections may be wired or wireless. Wired connections may be routed via the displaceable plate 45. It may also be provided that all motor modules 30 are connected to an energy supply at all times in order to enable the drive coils to be energized. The energy supply may also be routed via the displaceable plate 45.

In particular, it may be provided that the exchange motor modules 71 of the first exchange element 73 or the second exchange element 74 are permanently connected to the controller 5 for the purpose of data exchange and are also permanently supplied with energy, irrespective of a position of the exchange device 41.

In the embodiment example of the switch 40, which may be used in the linear transport system 1 of FIGS. 1 and 2, the exchange device 41 comprises a drive 46. With the aid of the drive 46, the exchange device 41 may be brought into the first position and into the second position. In particular, the drive 46 may drive the movable switch element 44. The displaceable plate 45 may therefore be moved with the aid of the drive 46. The displaceable plate 45 may be part of the movable switch element 44. In the embodiment shown, the drive 46 is embodied as a linear drive 55, which may also be referred to as a linear axis. This means that the linear drive 55 may be used to move the displaceable plate 45 in a translatory manner very simply, accurately, quickly and efficiently without any further interposed mechanical gears.

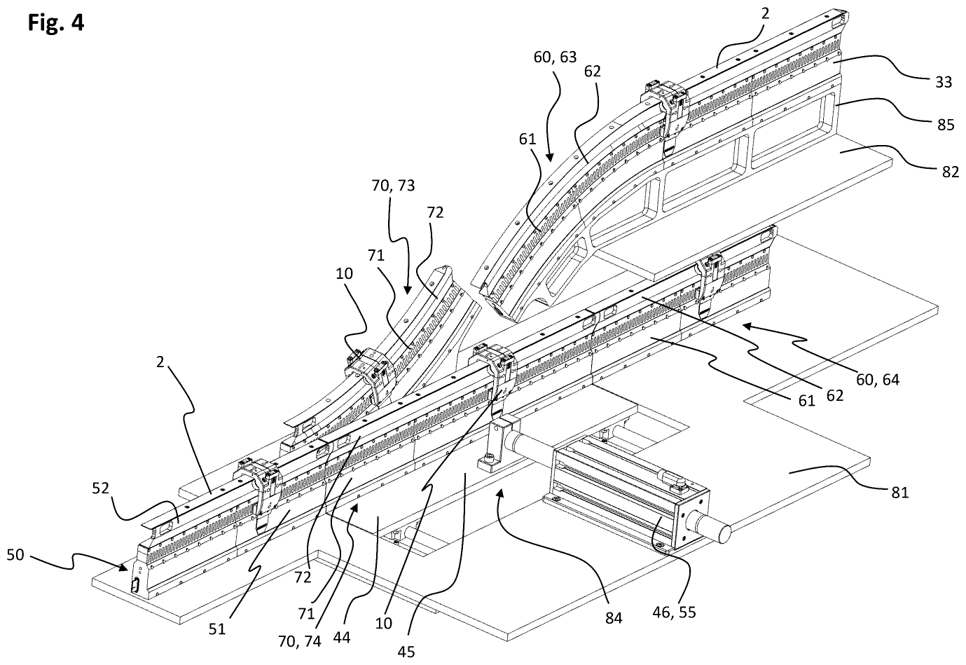

FIG. 4 shows an isometric view of the switch 40 of FIG. 3, in which the exchange device 41 has been moved to the second position. The retraction element 50 is now connected to the second extension element 64 via the second exchange element 74.

Furthermore, FIG. 4 shows a movable unit 10 that is currently being moved over the second exchange element 74.

The switch 40 shown in FIGS. 3 and 4 may be used directly as a switch 40 in the linear transport system 1 of FIGS. 1 and 2.

In the embodiment example of the switch 40 of FIGS. 3 and 4, the first exchange element 73 is curved. In particular, the exchange motor module 71 and the exchange rail element 72 of the first exchange element 73 are each curved, and the extension motor module 61 and the extension rail element 62 of the first extension element 63 are also each curved. Furthermore, in the embodiment example of the switch 40 of FIGS. 3 and 4, the second exchange element 74 is linear. In particular, the exchange motor module 71 and the exchange rail element 72 of the second exchange element 74 each have a linear embodiment. The retraction element 50 and the second extension element 64 are therefore aligned, so that the linear second exchange element 74 may establish a connection between the retraction element 50 and the second extension element 64. This embodiment is also shown in FIGS. 3 and 4.

In the embodiment example of the switch 40 in FIGS. 3 and 4, the linear transport system 1 comprises a primary plane. The primary plane is spanned by the retraction motor module 51 and the retraction rail element 52. In particular, the primary plane may be perpendicular with regard to a first fastening plate 81 on which the retraction motor module 51 and the extension motor module 61 of the second extendable element 64 are arranged. In particular, it may be provided that all immovable motor modules 33, including the retraction motor module 51 and the extension motor modules 61, are arranged in the primary plane. An example of such an arrangement is shown in FIG. 1. A first extension plane is perpendicular to the primary plane and is guided by the extension rail element 62 of the first extension element 63. The first extension plane is parallel with regard to the first fastening plate 81. The extension rail element 62 of the second extension element 64 lies at least partially in a second extension plane, wherein the second extension plane is parallel with regard to the first extension plane and thus also parallel with regard to the first fastening plate 81 and is arranged at a distance from the first extension plane. In this embodiment, the first extension element 63 and the second extension element 64 are provided in different planes. This is shown in FIGS. 3 and 4. Here, the first extension element 63 is arranged above the second extension element 64.

In the embodiment example of the switch 40 of FIGS. 3 and 4, the first fastening plate 81 is provided, on which the retraction element 50 and the second extension element 64 are arranged. A recess 84 in the first fastening plate 81 serves to accommodate the displaceable plate 45. The displaceable plate 45 may therefore be arranged in the recess 84. The drive 46 is also arranged on the first fastening plate 81. The first fastening plate 81 may be perpendicular with regard to the primary plane described above. A second fastening plate 82 is arranged parallel with regard to the first fastening plate 81. The first extension element 63 is fastened to the second fastening plate 82, wherein an optional support element 85 is provided here, with which a distance between the second fastening plate 82 and the first extension element 63 may be set. In particular, the displaceable plate 45 may be moved at an angle to the primary plane. In particular, the displaceable plate 45 is moved perpendicular with regard to the primary plane. A plane which is perpendicular to the primary plane and which is guided by the retraction rail element 52 may be referred to as the retraction plane.

The first exchange element 73 is curved out of a plane of the first fastening plate 81 in order to be able to reach the first extension element 63 arranged on the second fastening plate 82. The first exchange element 73 is therefore used to leave the retraction plane. The second exchange element 74 is linear in order to be able to reach the second extension element 64.

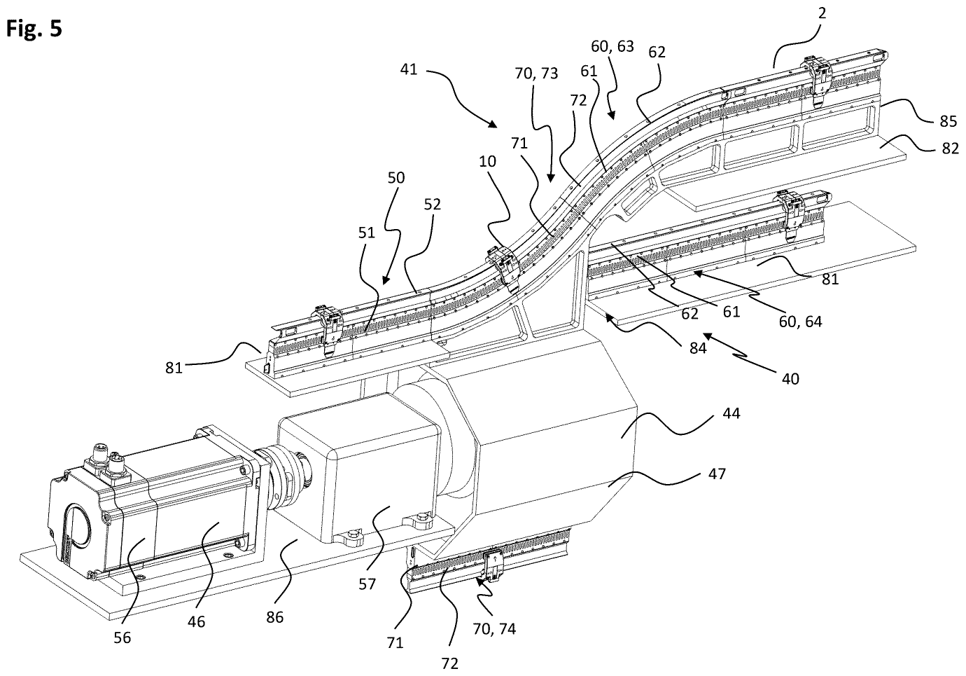

FIG. 5 shows an isometric view of a further embodiment of a switch 40, which may be used in the linear transport system 1 of FIGS. 1 and 2. In particular, this switch 40 again comprises the retraction element 50 with the retraction motor module 51 and the retraction rail element 52 as well as the extension elements 60 with the respective extension motor modules 61 and extension rail elements 62. The exchange device 41 comprises a movable switch element 44. In this embodiment example, in contrast to the embodiment example according to FIG. 3 and FIG. 4, the movable switch element 44 is embodied as a rotatable body 47. The first exchange element 73 with the associated exchange motor module 71 and exchange rail element 72 is permanently connected to the movable switch element 44. The second exchange element 74 with the associated exchange motor module 71 and exchange rail element 72 is permanently connected to the movable switch element 44. In particular, the exchange motor modules 71 of the first exchange element 73 or the second exchange element 74 may be attached to the movable switch element 44. In particular, the movable switch element 44 may be used to bring the first exchange element 73 or the exchange device 41 into the first position and the second exchange element 74 or the exchange device 41 into the second position. The first position is shown in FIG. 5. The retraction element 50 is connected to the first extension element 63 via the first exchange element 73.

The switch 40 in FIG. 5 also comprises a drive 46. With the aid of the drive 46, the exchange device 41 may be brought into the first position and into the second position. In particular, the drive 46 may drive the movable switch element 41. The rotatable body 47 may therefore be rotated with the aid of the drive 46. The rotatable body 47 may be part of the movable switch element 41. In the embodiment shown, the drive 46 is embodied as a rotary drive 56. Optionally, as shown herein, as well, a transmission 57 may be interposed between the rotary drive 56 and the rotatable body 47. Thus, with the aid of the rotary drive 56 and the optionally available gear 57, a rotational twisting of the rotatable body 47 between the first position and the second position may be carried out very simply, accurately, quickly and efficiently.

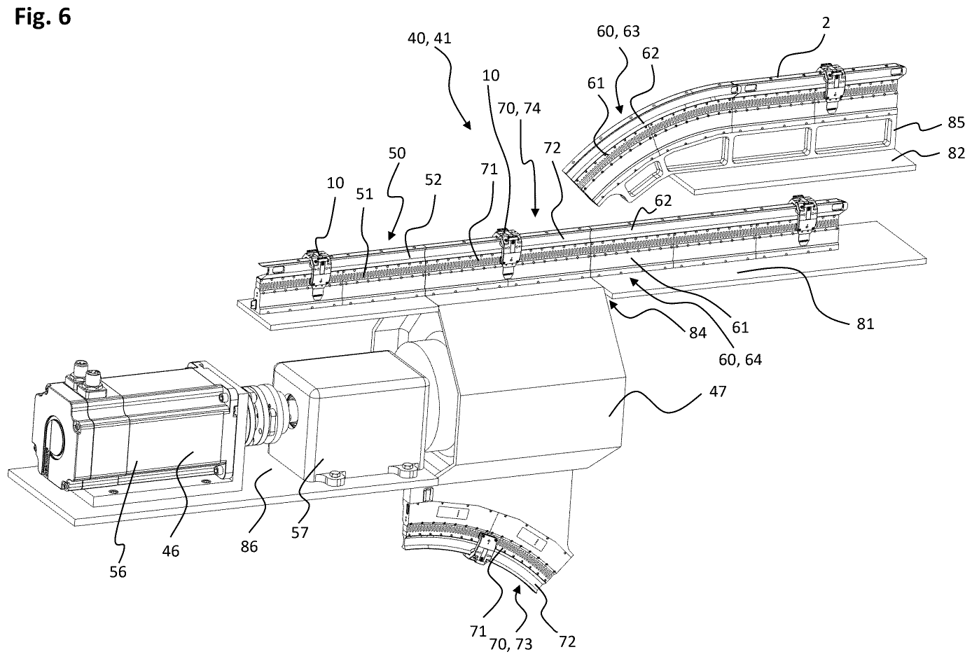

FIG. 6 shows an isometric view of the switch 40 of FIG. 5, in which the exchange device 41 has been moved to the second position. The retraction element 50 is now connected to the second extension element 64 via the second exchange element 74.

In the switch 40 of FIGS. 5 and 6, the exchange elements 70 are therefore arranged on a rotatable body 47. It is provided that the first exchange element 73 and the second exchange element 74 are arranged opposite to each other on the rotatable body 47. However, the exchange elements 70 may also be arranged at a different angle with regard to one another in order to reduce the rotation of the rotatable body 47 required to change the exchange elements 70.

It may be provided that in the switch 40 of FIGS. 5 and 6, the controller 5 is permanently connected to all motor modules 30, i.e. in particular also to the exchange motor modules 71 of the first exchange element 73 or the second exchange element 74 and the extension motor modules 61 of the first extension element 63 or the second extension element in such a way that data communication between the controller 5 and all motor modules 30 is possible, for example in order to obtain position detector data and/or other sensor and/or system data from the motor modules 30, that data communication between the controller 5 and all motor modules 30 is possible, for example to send position detector data and/or further sensor and/or system data from the motor modules 30 to the controller 5 and/or to send, for example, actuation signals for the coils of the motor modules 30 and/or further data from the controller 5 to the motor modules 30. In particular, data communication between the controller 5 and the exchange motor modules 71 of the first exchange element 73 or the second exchange element 74 is therefore possible without corresponding connections being shown in FIG. 3. The connections may be wired or wireless. Wired connections may be routed via the rotatable body 47. It may also be provided that all motor modules 30 are connected to an energy supply at all times in order to allow for energizing of the drive coils. The energy supply may also be routed via the rotatable body 47.

In particular, it may be provided that the exchange motor modules 71 of the first exchange element 73 or the second exchange element 74 are permanently connected to the controller 5 for the purpose of data exchange and are also permanently supplied with energy, irrespective of a position of the exchange device 41.

In the embodiment example of the switch 40 of FIGS. 5 and 6, the linear transport system 1 also comprises a primary plane, which is defined analogously to the primary plane of FIG. 5 and is perpendicular with regard to a first fastening plate 81 on which the extension motor module 61 of the second extension element 64 is arranged. The primary plane is spanned by the retraction motor module 51 and the retraction rail element 52. In particular, it may be provided that all immovable motor modules 33, including the retraction motor module 51 and the extension motor modules 61, are arranged in the primary plane. An example of such a configuration is shown in FIG. 1. A first extension plane is perpendicular to the primary plane and is guided by the extension rail element 62 of the first extension element 63. The extension rail element 62 of the second extension element 64 lies at least partially in a second extension plane, wherein the second extension plane is parallel with regard to the first extension plane and is arranged at a distance from the first extension plane. In this embodiment, the first extension element 63 and the second extension element 64 are provided in different planes. This is shown in FIGS. 5 and 6. Here, the first extension element 63 is arranged above the second extension element 64.

The first extension element 63 and the second extension element 64 are each identical in the embodiment examples of the switch 40 of FIGS. 3 and 4 or 5 and 6. The switches 40 may therefore be provided with a first extension element 63 and a second extension element 64 as shown, for example, in FIG. 1, irrespective of the configuration of the drive 46 and the movable switch element 44.

In the embodiment example of the switch 40 of FIGS. 5 and 6, a first fastening plate 81 is provided, on which the retraction element 50 and the second extension element 64 are arranged. A recess 84 in the first fastening plate 81 serves to accommodate the exchange elements 70 of the rotatable body 47. The rotatable body 47 may, for example, be arranged under the recess 84 in such a way that the recess 84 is large enough that the exchange elements 70 do not come into contact with the first fastening plate 81 when the rotatable body 47 rotates. The drive 46 may be arranged on a drive fastening plate 86. The first fastening plate 81 may be perpendicular with regard to the primary plane described above. A second fastening plate 82 is arranged in parallel to the first fastening plate 81. The first extension element 63 is fastened to the second fastening plate 82, wherein an optional support element 85 is provided here, with which a distance between the second fastening plate 82 and the first extension element 63 may be set.

In an embodiment example of the linear transport system 1 or of the switch 40, respectively, the exchange device 41 comprises more than two exchange elements 70, each with an exchange motor module 71 and an exchange rail element 72 belonging to the guide rail 2. The switch 40 also comprises a number of static extension elements 60 adapted to the number of exchange elements 70, each with an extension motor module 61 and an extension rail element 62 belonging to the guide rail 2. This makes it possible to achieve more than two extension elements 60 with the aid of the switch 40. Such switches 40 are described below.

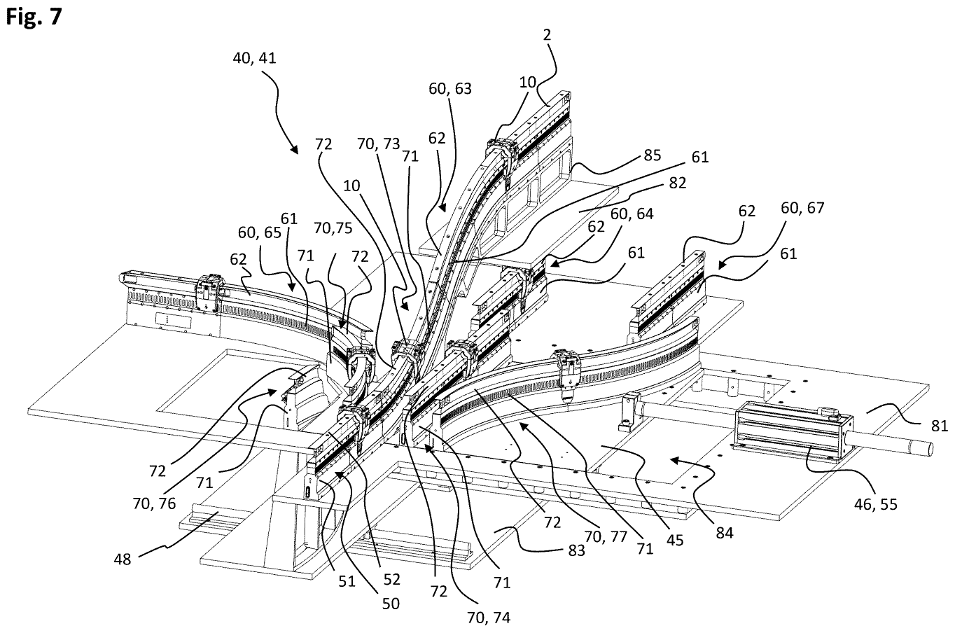

FIG. 7 shows an isometric view of an embodiment of a switch 40 that may be used in the linear transport system 1 of FIGS. 1 and 2. This switch 40 corresponds to the switch 40 of FIGS. 3 and 4, unless differences are described below.

The switch 40 comprises a retraction element 50 with a retraction motor module 51 and a retraction rail element 52 belonging to the guide rail 2. Furthermore, analogous to FIGS. 3 and 4, the switch 40 or the exchange device 41 of the switch 40 comprises a first exchange element 73 with an exchange motor module 71 and an exchange rail element 72 belonging to the guide rail 2 as well as a second exchange element 74 with an exchange motor module 71 and an exchange rail element 72 belonging to the guide rail 2. Furthermore, analogous to FIGS. 3 and 4, the switch 40 comprises a first extension element 63 with an extension motor module 61 and an extension rail element 62 belonging to the guide rail 2 as well as a second extension element 64 having an extension motor module 61 and an extension rail element 62 belonging to the guide rail 2. In addition, the switch 40 comprises the displaceable plate 45 with a drive 46 and the first fastening plate 81 as well as the second fastening plate 82 analogous to FIGS. 3 and 4. Furthermore, the switch 40 or the exchange device 41 of the switch 40 is shown in the first position in FIG. 7.

The switch 40 of FIG. 7 also comprises further exchange elements 70 and further extension elements 60. In particular, the exchange device 41, i.e. the displaceable plate 45, comprises a third exchange element 75 with exchange motor module 71 and exchange rail element 72 belonging to the guide rail 2, a fourth exchange element 76 with exchange motor module 71 and exchange rail element 72 belonging to the guide rail 2 and a fifth exchange element 77 with exchange motor module 71 and exchange rail element 72 belonging to the guide rail 2. Furthermore, the switch 40 comprises a third extension element 65 with extension motor module 61 and extension rail element 62 belonging to guide rail 2, a fourth extension element 66 with extension motor module 61 and extension rail element 62 belonging to guide rail 2 and a fifth extension element 67 with extension motor module 61 and extension rail element 62 belonging to guide rail 2. The fourth extension element 66 is partially concealed in the illustration by the first fastening plate 81 and the displaceable plate 45. Analogous to the description of the connection of the retraction element 50 to the first extension element 63 or the second extension element 64 according to the description of FIGS. 3 and 4, the retraction element 50 may be connected to the third extension element 65 via the third exchange element 75. The retraction element 50 may be connected to the fourth extension element 66 via the fourth exchange element 76. The retraction element 50 may be connected to the fifth extension element 67 via the fifth exchange element 77. All these connections may be made by a translatory movement of the displaceable plate 45, possibly driven by the drive 46.

The third extension element 65 and the fifth extension element 67 are also arranged on the first fastening plate 81. In particular, the extension rail elements 62 of the second extension element 64, the third extension element 65 and the fifth extension element 67 form a plane which may be in parallel to the first fastening plate 81 and perpendicular with regard to the primary plane. If this plane is guided by the retraction rail element 52, this plane corresponds to the retraction plane already described above. The first exchange element 73 is again curved out of a plane of the first fastening plate 81 in order to be able to reach the first extension element 63 arranged on the second fastening plate 82.

FIG. 7 further shows an optional third fastening plate 83, which is in parallel to the first fastening plate 81 and the second fastening plate 82. The third fastening plate 83 and the second fastening plate 82 are arranged on different sides of the first fastening plate 81. The fourth extension element 66 may be fastened to the third fastening plate 83. Furthermore, a rail 48 may be arranged on the third fastening plate 83, wherein the rail 48 may serve to guide a movement of the exchange device 41 or the displaceable plate 45. Such a rail 48 may also be provided for the switch 40 of FIGS. 3 and 4.

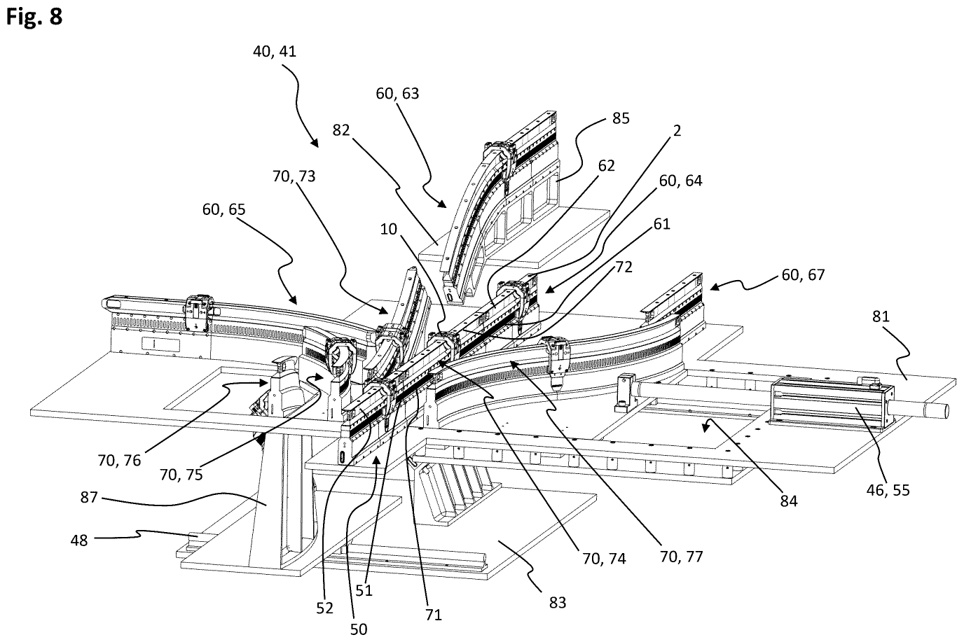

FIG. 8 shows the switch 40 of FIG. 7 in the second position of the switch 40 or the exchange device 41 of the switch 40, so that the retraction element 50 is now connected to the second extension element 64 via the second exchange element 74. The second exchange element 74 is again linear in order to be able to reach the second extension element 64. Thus, the structure of FIG. 8 essentially corresponds to the structure of FIG. 4. The explanations made in this context apply here in the same way.

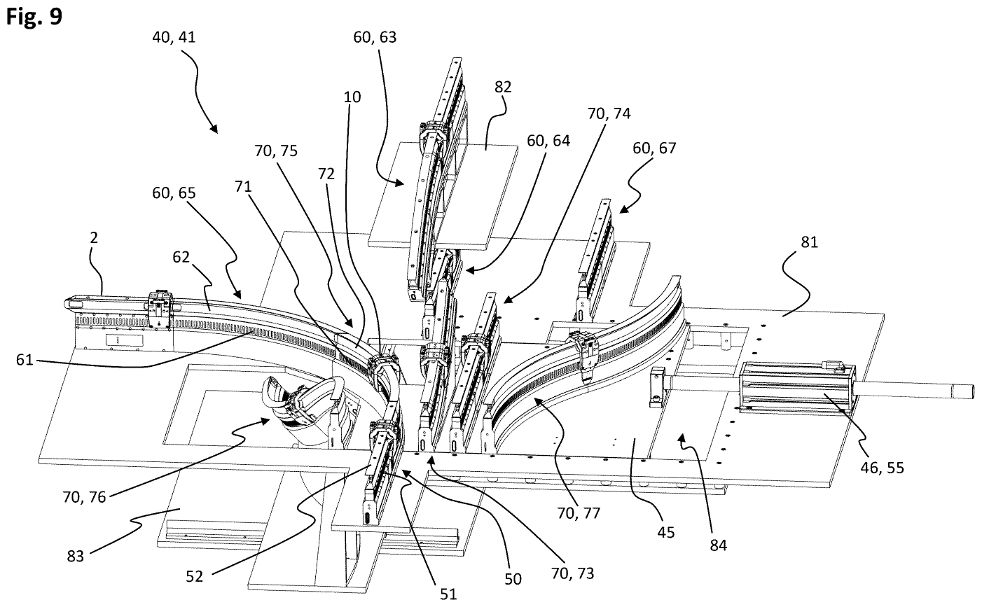

FIG. 9 shows the switch 40 of FIGS. 7 and 8 in a third position of the switch 40 or the exchange device 41 of the switch 40. The retraction element 50 is now connected to the third extension element 65 via the third exchange element 75. The third exchange element 75 is curved, as well. In contrast to the first exchange element 73, which is arranged completely in the primary plane, the third exchange element 75 leaves the primary plane. Together with the third extension element 65, the third exchange element 75 forms a 90-degree curve in a plane parallel to the first fastening plate 81.

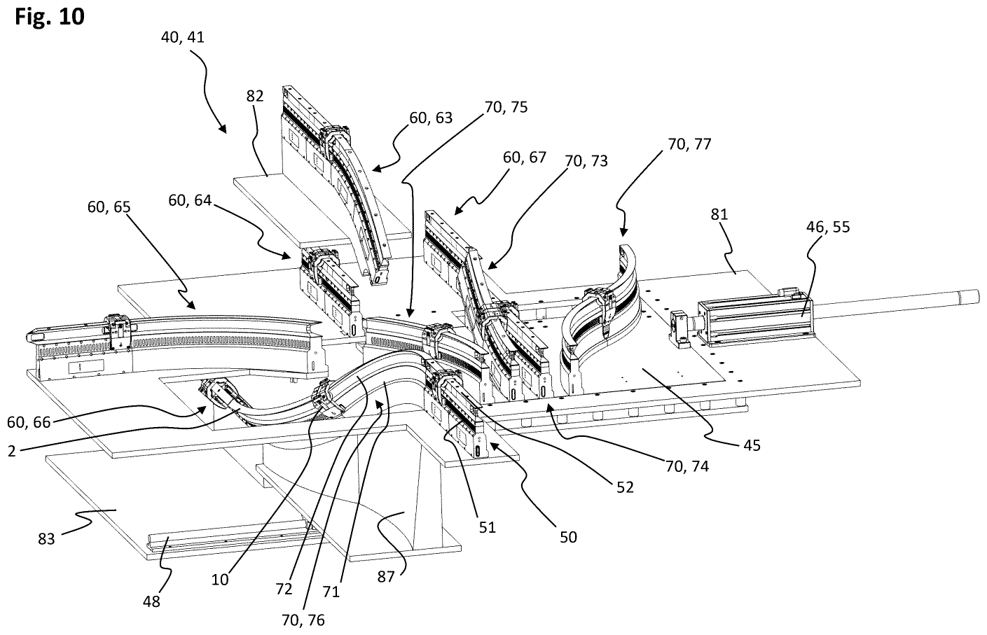

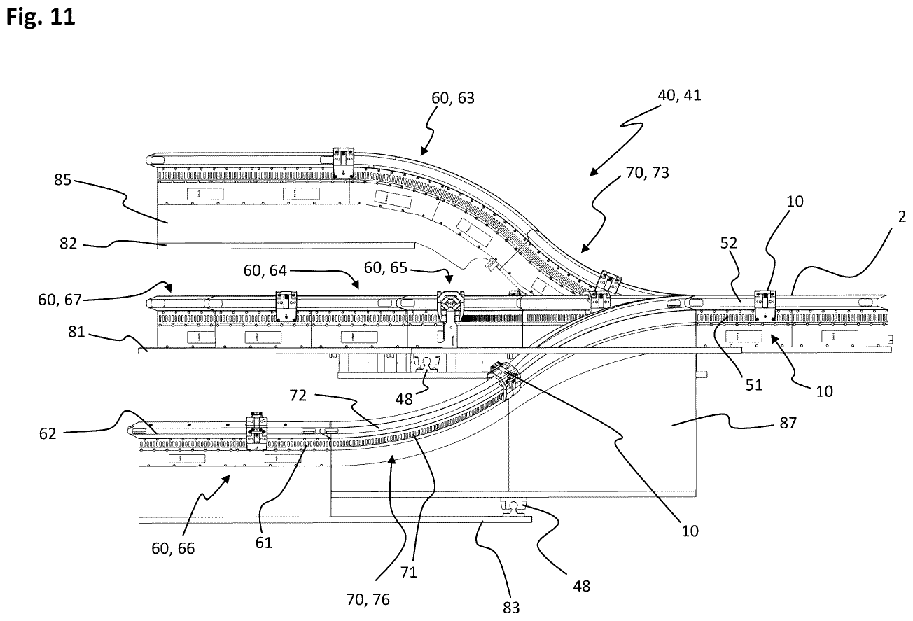

FIGS. 10 and 11 show the switch 40 of FIGS. 7 to 9 in a fourth position of the switch 40 or the exchange device 41 of the switch 40. The retraction element 50 is now connected to the fourth extension element 66 via the fourth exchange element 76. The fourth exchange element 76 is curved, as well. In particular, the fourth exchange element 76 is curved in such a way that the fourth extension element 66, which is arranged outside of both the main extension plane and below the retraction plane, is connected to the retraction element 50 via the fourth exchange element 76. Furthermore, the fourth extension element 66 is rotated in itself by 45 degrees, so that a plane through the extension motor element 61 of the fourth extension element 66 and the extension rail element 62 of the fourth extension element 66 is at a 45 degree angle to the primary plane as well as at a 45 degree angle to the retraction plane.

Furthermore, it may be seen in FIG. 11 that the displaceable plate 45 is arranged in two planes, between which an offset structure 87 is arranged. The offset structure 87 is particularly advantageous if one of the exchange elements 70, in this case the fourth exchange element 76, is to be guided into a plane below the first fastening plate 81. In addition to the guide rail on the third fastening plate 83 already described in connection with FIG. 7, FIG. 11 also shows a guide rail 48 below the first fastening plate 81. Two or even more than two guide rails 48 may therefore serve to guide the movement of the exchange device 41 or the displaceable plate 45.

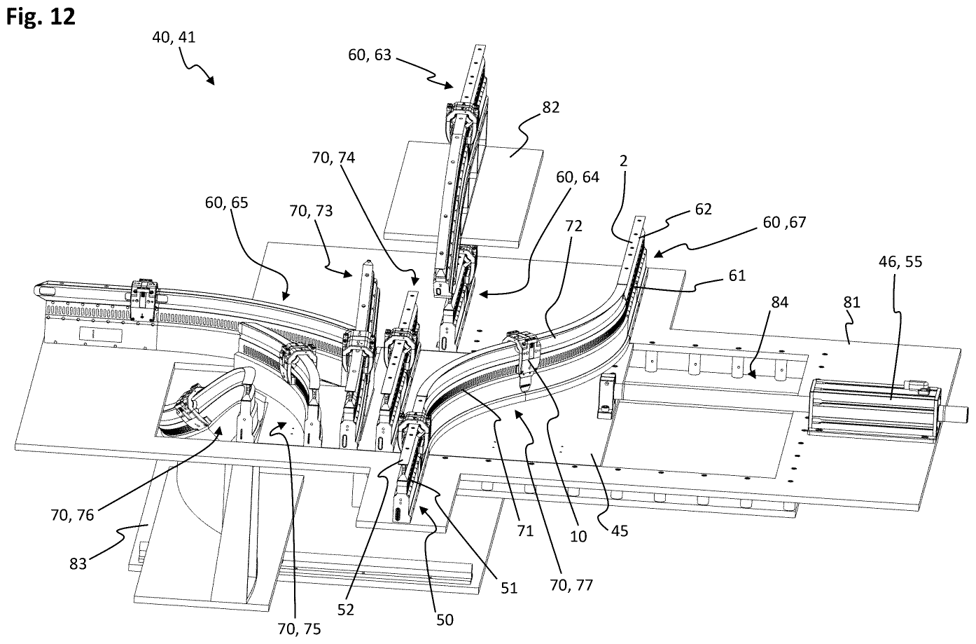

FIG. 12 shows the switch 40 of FIGS. 7 to 11 in a fifth position of the switch 40 or the exchange device 41 of the switch 40. The retraction element 50 is now connected to the fifth extension element 67 via the fifth exchange element 77. The fifth exchange element 77 is curved, as well. The fifth extension element 67 is arranged parallel with regard to the second extension element 64. The fifth exchange element 77 is curved in such a way that it is guided out of the primary plane and then guided into a plane that is arranged in parallel to the primary plane.

In the switch 40 of FIGS. 7 to 12, the exchange elements 70 are arranged on the displaceable plate 45 in such a way that the fourth exchange element 76 is arranged furthest away from the drive 46 and then, moving ever closer to the drive 46, the third exchange element 75, the first exchange element 73, the second exchange element 74 and the fifth exchange element 77. Of course, the exchange elements 70 may also be arranged in a different order on the displaceable plate 45. Furthermore, any combination of two, three or four of the exchange elements 70 shown as examples in FIGS. 7 to 12 may be arranged on the displaceable plate 45 and the associated extension elements 60. Furthermore, other, differently shaped exchange elements 70 with suitably embodied extension elements 60 may also be provided.

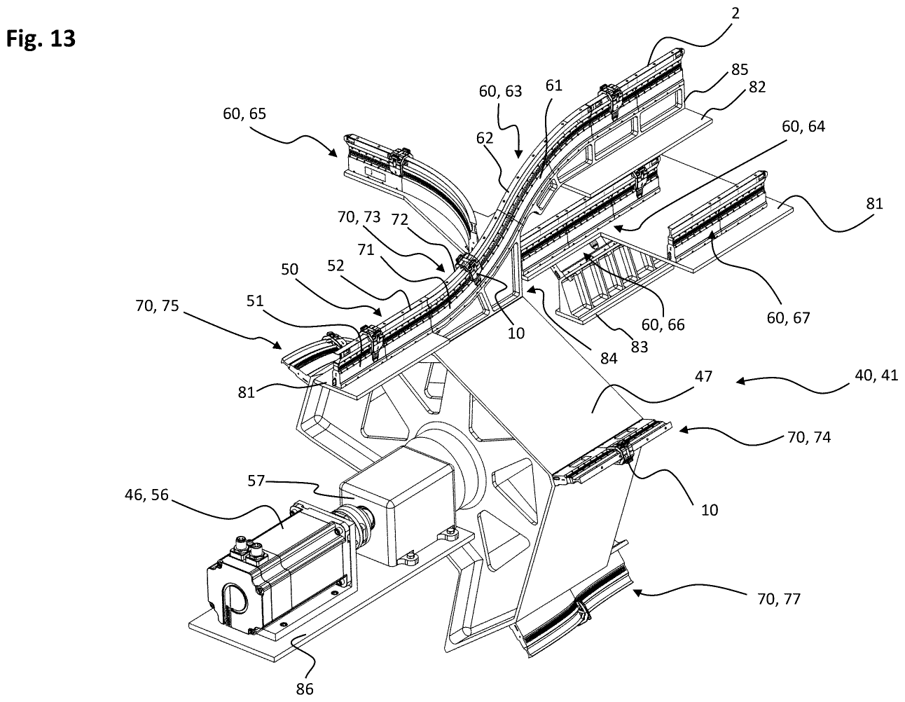

FIG. 13 shows an isometric view of an embodiment of a switch 40 that may be used in the linear transport system 1 of FIGS. 1 and 2. This switch 40 corresponds to the switch of FIGS. 5 and 6, unless differences are described below.

The switch 40 comprises a retraction element 50 with a retraction motor module 51 and a retraction rail element 52 belonging to the guide rail 2. Furthermore, analogous to FIGS. 5 and 6, the switch 40 or the exchange device 41 of the switch 40 comprises a first exchange element 73 with an exchange motor module 71 and an exchange rail element 72 belonging to the guide rail 2 as well as a second exchange element 74 with an exchange motor module 71 and an exchange rail element 72 belonging to the guide rail 2. Furthermore, analogous to FIGS. 5 and 6, the switch 40 comprises a first extension element 63 with an extension motor module 61 and an extension rail element 62 belonging to the guide rail 2 and a second extension element 64 with an extension motor module 61 and an extension rail element 62 belonging to the guide rail 2. In addition, the switch 40 comprises the rotatable body 47 with the drive 46 and the first fastening plate 81 as well as the second fastening plate 82 and the drive fastening plate 86 analogous to FIGS. 5 and 6. Furthermore, the switch 40 or the exchange device 41 of the switch 40 is shown in the first position in FIG. 13.

The switch 40 of FIG. 13 also comprises further exchange elements 70 and further extension elements 60. In particular, the exchange device 41, i.e. the rotatable body 47, comprises a third exchange element 75 with exchange motor module 71 and exchange rail element 72 belonging to the guide rail 2, a fourth exchange element 76 with exchange motor module 71 and exchange rail element 72 belonging to the guide rail 2 and a fifth exchange element 77 with exchange motor module 71 and exchange rail element 72 belonging to the guide rail 2. However, based on the view in FIG. 13, only the first exchange element 73, the second exchange element 74 and the fifth exchange element 77 are visible. The third exchange element 75 and the fourth exchange element 76 are concealed by the rotatable body 47. The shape of the first exchange element 73 corresponds to that of the first exchange element 73 of the switch 40 of FIGS. 7 to 12. The shape of the second exchange element 74 corresponds to that of the second exchange element 74 of the switch 40 of FIGS. 7 to 12. The shape of the third exchange element 75 corresponds to that of the third exchange element 75 of the switch 40 of FIGS. 7 to 12. The shape of the fourth exchange element 76 corresponds to that of the fourth exchange element 76 of the switch 40 of FIGS. 7 to 12. The fifth exchange element 77 corresponds in shape to the fifth exchange element 77 of the switch 40 of FIGS. 7 to 12. Furthermore, the switch 40 comprises a third extension element 65 with extension motor module 61 and extension rail element 62 belonging to the guide rail 2, a fourth extension element 66 with extension motor module 61 and extension rail element 62 belonging to the guide rail 2 and a fifth extension element 67 with extension motor module 61 and extension rail element 62 belonging to the guide rail 2. The fourth extension element 66 is partially covered by the first fastening plate 81. Analogous to the description of the connection of the retraction element 50 to the first extension element 63 or the second extension element 64 according to the description of FIGS. 5 and 6, the retraction element 50 may be connected to the third extension element 65 via the third exchange element 75. The retraction element 50 may be connected to the fourth extension element 66 via the fourth exchange element 76. The retraction element 50 may be connected to the fifth extension element 67 via the fifth exchange element 77. All these connections may be made by a rotating movement of the rotatable body 47, possibly driven by the drive 46.

The third extension element 65 and the fifth extension element 67 are also arranged on the first fastening plate 81. In particular, the extension rail elements 62 of the second extension element 64, the third extension element 65 and the fifth extension element 67 form a plane which may be parallel with regard to the first fastening plate 81 and perpendicular to the primary plane. If this plane is guided by the retraction rail element 52, this plane corresponds to the retraction plane already described above. The first exchange element 73 is again curved out of a plane of the first fastening plate 81 in order to be able to reach the first extension element 63 arranged on the second fastening plate 82.

FIG. 13 also shows an optional third fastening plate 83, which is in parallel to the first fastening plate 81 and the second fastening plate 82. The third fastening plate 83 and the second fastening plate 82 are arranged on different sides of the first fastening plate 81. The fourth extension element 66 may be fastened to the third fastening plate 83.

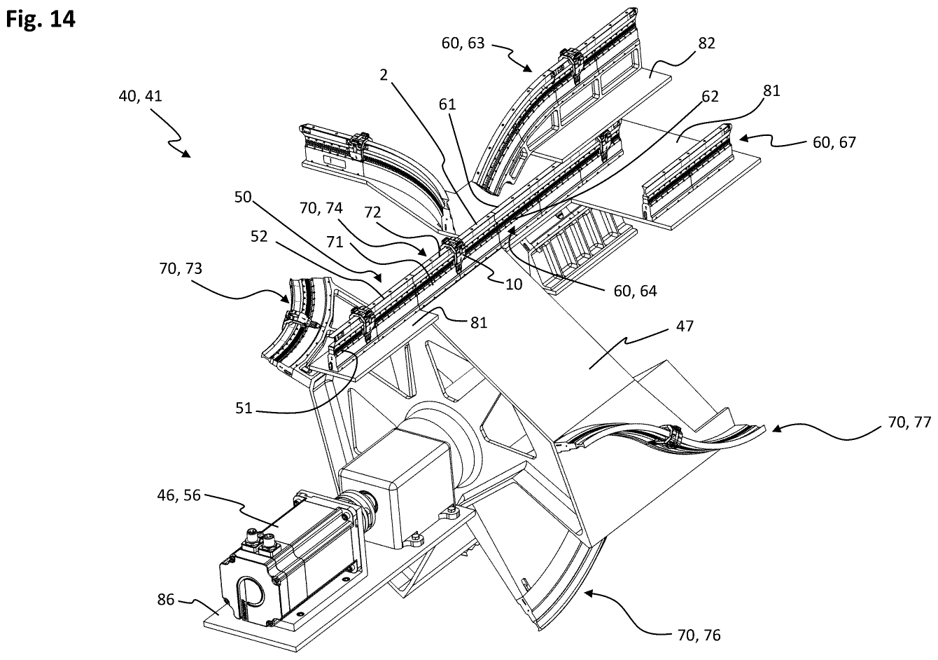

FIG. 14 shows the switch 40 of FIG. 13 in the second position of the switch 40 or the exchange device 41 of the switch 40, so that the retraction element 50 is now connected to the second extension element 64 via the second exchange element 74. The second exchange element 74 is again linear in order to be able to reach the second extension element 64. In the embodiment example of FIGS. 13 and 14, the first exchange element 73 and the second exchange element 74 are not arranged opposite to one another on the rotatable body 47.

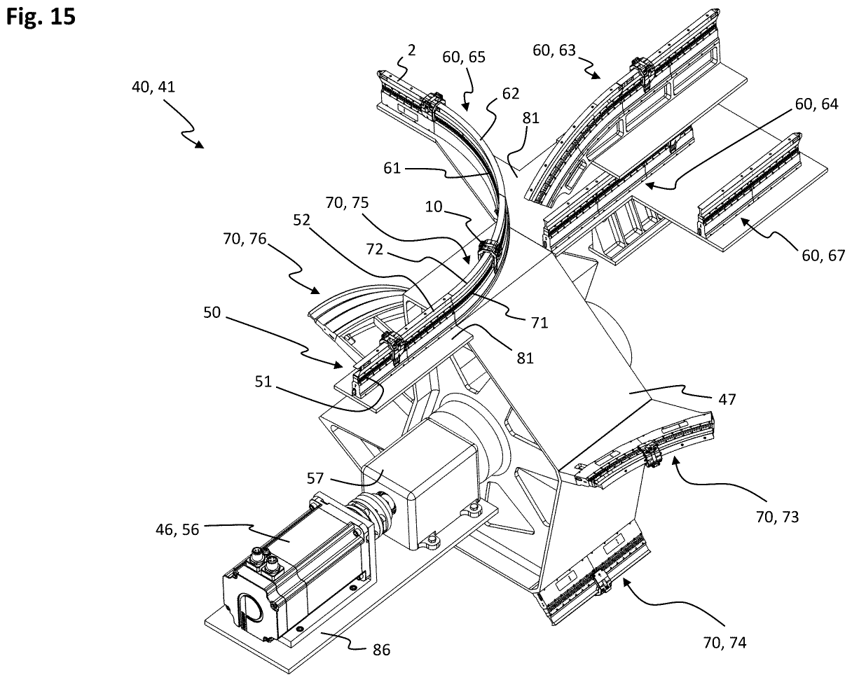

FIG. 15 shows the switch 40 of FIGS. 13 and 14 in a third position of the switch 40 or, respectively, of the exchange device 41 of the switch 40. The retraction element 50 is now connected to the third extension element 65 via the third exchange element 75. The third exchange element 75 is curved, as well. In contrast to the first exchange element 73, which is arranged completely in the primary plane, the third exchange element 75 leaves the primary plane. Together with the third extension element 65, the third exchange element 75 forms a 90-degree curve in a plane parallel to the first fastening plate 81.

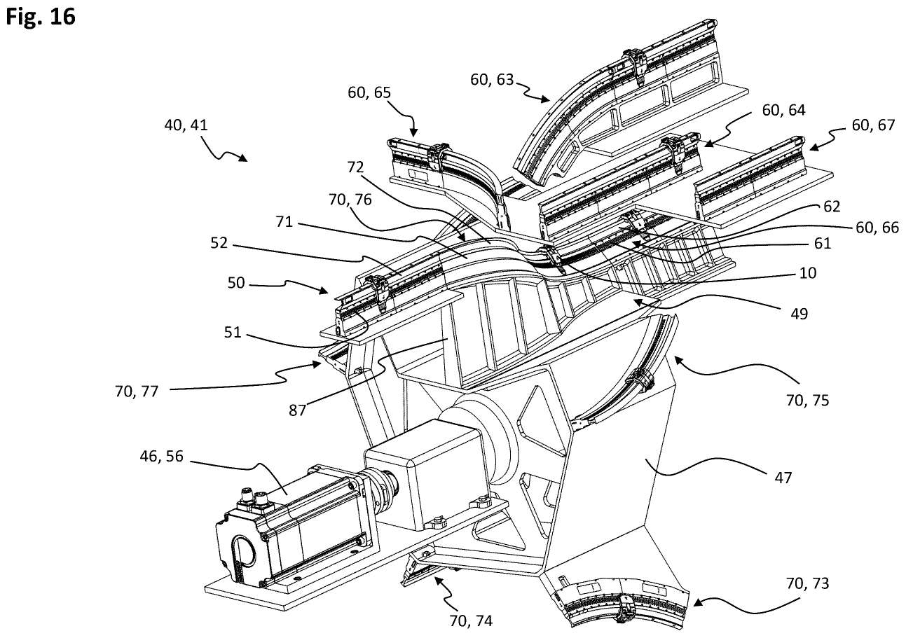

FIG. 16 shows the switch 40 of FIGS. 13 to 15 in a fourth position of the switch 40 or the exchange device 41 of the switch 40. The retraction element 50 is now connected to the fourth extension element 66 via the fourth exchange element 76. The fourth exchange element 76 is curved, as well. The fourth exchange element 76 is curved in such a way that the fourth extension element 66, which is arranged outside of both the main extension plane and below the retraction plane, is connected to the retraction element 50 via the fourth exchange element 76. Furthermore, the fourth extension element 66 is rotated in itself by 45 degrees, so that a plane through the extension motor element 61 of the fourth extension element 66 and the extension rail element 62 of the fourth extension element 66 is at a 45 degree angle to the primary plane as well as at a 45 degree angle to the retraction plane. The rotatable body 47 comprises a recess 49 in which the fourth exchange element 76 is at least partially arranged.

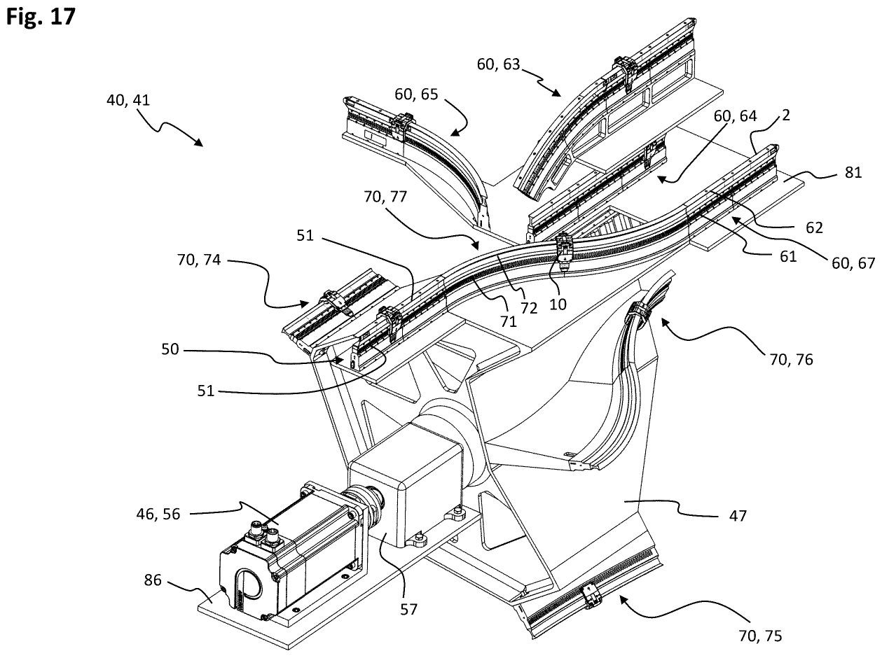

FIG. 17 shows the switch 40 of FIGS. 13 to 16 in a fifth position of the switch 40 or the exchange device 41 of the switch 40. The retraction element 50 is now connected to the fifth extension element 67 via the fifth exchange element 77. The fifth exchange element 77 is curved, as well. The fifth extension element 67 is arranged parallel to the second extension element 64. The fifth exchange element 77 is curved in such a way that it is guided out of the primary plane and then guided into a plane parallel to the primary plane.

In the switch 40 of FIGS. 13 to 17, the exchange elements 70 are arranged on the rotatable body 47 in such a way that, when the rotatable body 47 rotates clockwise, the first exchange element 73 is followed by the second exchange element 74, then the fifth exchange element 77, then the fourth exchange element 76 and then the third exchange element 75. Of course, the exchange elements 70 may also be arranged in a different order on the rotatable body 47. Furthermore, any combination of two, three or four of the exchange elements 70 shown as examples in FIGS. 13 to 17 may be arranged on the rotatable body 47 and the associated extension elements 60. Furthermore, other, differently shaped exchange elements 70 with suitably embodied extension elements 60 may also be provided.

In an embodiment of the linear transport system 1 or, respectively, of the switch 40, at least one exchange element 70 is curved. In particular, both exchange elements 70 or more than one exchange element 70 may also be curved. This allows the switch 40 or the linear transport system 1 to be made even more flexible. In the embodiment examples of FIGS. 3 to 17, the first exchange element 73 and in the embodiment examples of FIGS. 7 to 17, the third exchange element 75, the fourth exchange element 76 and the fifth exchange element 77 are each curved.

It may be provided that the retraction element 50, the exchange elements 70 and the extension elements 60 are arranged in such a way that movement of the exchange device 41 is not mechanically impeded. In particular, it may be provided that the guide rails 2 of the retraction element 50, exchange elements 70 and extension elements 60 engage with one another. Furthermore, a guide rail gap may be provided on the guide rails 2 at the transition between the retraction element 50 and the exchange elements 70 and between the exchange elements 70 and the extension elements 60, which is a maximum of twenty percent, preferably a maximum of ten percent, of a diameter of the rollers 11 of the movable unit 10.

In an embodiment of the linear transport system 1 or, respectively, of the switch 40, the linear transport system 1 or the switch 40 comprises a primary plane. The primary plane is spanned by the retraction motor module 51 and the retraction rail element 52. A first extension plane is perpendicular with regard to the primary plane and is guided by the extension rail element 62 of the first extension element 63. The extension rail element 62 of the second extension element 64 also lies in the first extension plane.

In an embodiment of the linear transport system 1 or, respectively, of the switch 40, the linear transport system comprises a primary plane. The primary plane is spanned by the retraction motor module 51 and the retraction rail element 52. A first extension plane is perpendicular with regard to the primary plane and is guided by the extension rail element 62 of the first extension element 63. The extension rail element 62 of the second extension element 64 lies at least partially in a second extension plane, wherein the second extension plane is parallel with regard to the first extension plane and is arranged at a distance from the first extension plane. In this embodiment, extension elements 60 are therefore provided in different planes. In the embodiments of FIGS. 3 to 6, this is the case, for example, for the first extension element 63 and the second extension element 64. In the embodiments shown in FIGS. 7 to 17, the first extension element 63 and the second extension element 64 are also located in different extension planes. Furthermore, the extension rail elements 62 of the third extension element 65 and the fifth extension element 67 are arranged in the second extension plane, while the extension rail element 62 of the fourth extension element 66 lies in a third extension plane, the third extension plane being arranged at a distance from the first extension plane and the second extension plane and the third extension plane also being in parallel to the first extension plane and the second extension plane, respectively.

In an embodiment example of the linear transport system 1 or, respectively, of the switch 40, in the first position the retraction motor module 51 is flush with the exchange motor module 71 of the first exchange element 73 and the exchange motor module 71 of the first exchange element 73 is flush with the extension motor module 61 of the first extension element 63. In the second position, the retraction motor module 51 is flush with the exchange motor module 71 of the second exchange element 74 and the exchange motor module 71 of the second exchange element 74 is flush with the extension motor module 61 of the second extension element 64. In this way, a simple transition of the movable unit 10 may be achieved.

In an embodiment example of the linear transport system 1 or, respectively, of the switch 40, a retraction gap with a predetermined retraction gap width is arranged in the first position between the retraction motor module 51 and the exchange motor module 71 of the first exchange element 73. In particular, the retraction gap width may be smaller than a coil distance between two drive coils 34 of the motor modules 33.

In an embodiment example of the linear transport system 1 or, respectively, of the switch 40, an extension gap with a predetermined extension gap width is arranged in the first position between the exchange motor module 71 of the first exchange element 73 and the extension motor module 61 of the first extension element 63. In particular, the extension gap width may be smaller than a coil distance between two drive coils 34 of the motor modules 33.

In an embodiment of the linear transport system 1 or, respectively, of the switch 40, the drive coils 34 are arranged within the motor modules 33 in such a way that two drive coils 34 comprise a predetermined distance in each case. A drive coil 34 arranged at the rear in the direction of travel in the retraction motor module 50 and a drive coil 34 arranged at the front in the direction of travel in the exchange motor module 71 of the first exchange element 73 also have the predetermined distance when the exchange device 41 is arranged in the first position. The drive coil 34 arranged at the rear in the direction of travel in the retraction motor module 51 and a drive coil 34 arranged at the front in the direction of travel in the exchange motor module 71 of the second exchange element 74 also have the predetermined distance when the exchange device 41 is arranged in the second position. With this configuration, an identical drive coil distance between the retraction motor module 51 and the exchange motor modules 71 may particularly be achieved. This drive coil distance may correspond to the drive coil distance generally present in the motor modules 33. This distance may also be provided in each case for a drive coil 34 of the exchange motor module 71 of the third exchange element 75, the fourth exchange element 76 and the fifth exchange element 77 arranged at the front in the direction of travel.

In an embodiment example of the linear transport system 1 or, respectively, of the switch 40, a drive coil 34 arranged at the rear in the direction of travel in the exchange motor module 71 of the first exchange element 73 and a drive coil 34 arranged at the front in the direction of travel in the extension motor module 61 of the first extension element 63 also have the predetermined distance when the exchange device 41 is arranged in the first position. A drive coil 34 arranged at the rear in the direction of travel in the exchange motor module 71 of the second exchange element 74 and a drive coil 34 arranged at the front in the direction of travel in the extension motor module 61 of the second extension element 64 also have the predetermined distance when the exchange device 41 is arranged in the second position. With this embodiment, an identical drive coil distance between the exchange motor modules 71 and the extension motor modules 61 may particularly be achieved. This drive coil distance may correspond to the drive coil distance generally present in the motor modules 33. This distance may also be achieved in each case for a drive coil 34 of the exchange motor module 71 of the third exchange element 75, which is arranged at the rear in the direction of travel, and a drive coil 34 of the extension motor module 61 of the third extension element 65, which is arranged at the front in the direction of travel, a drive coil 34 of the fourth exchange element 76 arranged at the rear in the direction of travel and a drive coil 34 of the extension motor module 61 of the fourth extension element 66 arranged at the front in the direction of travel and a drive coil 34 of the fifth exchange element 77 arranged at the rear in the direction of travel and a drive coil 34 of the extension motor module 61 of the fifth extension element 67 arranged at the front in the direction of travel may be provided.

In all embodiments of the switch 40 of FIGS. 1 to 17, it may be provided that a movable unit 10 is moved to one of the exchange elements 70 and stopped there. If the switching device 41 is now moved, the movable unit 10 may be held in place by the exchange motor module 71 of the corresponding exchange element 70 and another movable unit 10 may be moved over the switch. The currently unused exchange elements 70 may therefore also be used to buffer the movable units 10. As an alternative or in addition, it may be provided that a movable unit 10 is moved to one of the exchange elements 70 and stopped there. If the exchange device 41 is moved now, a further extension element 60 may be adjacent to the relevant exchange element 70, so that the movable unit 10 may now be moved to this further extension element 60.

FIG. 18 shows a flow chart 100 of a method for operating a linear transport system 1 with the aid of a switch 40. This linear transport system 1 may be embodied like one of the linear transport systems 1 according to the previously described FIGS. 1 to 17. In this method, in a first method step 101, a position of an exchange device 41 of the linear transport system 1, i.e. in particular a switch 40 of the linear transport system 1, is determined. In a second method step 102 carried out thereafter, a control program is selected on the basis of the position. Furthermore, in a subsequent third method step 103, the drive coils 34 of the linear transport system 1 are logically switched over on the basis of the position. This method may be carried out in particular by a controller 5 of the linear transport system 1.

In an embodiment of the method for operating the linear transport system 1, in an optional fourth method step, which is carried out between the second method step 102 and the third method step 103, a position of the movable unit 10 is determined with the aid of position detectors 36 arranged within the motor modules 33. Furthermore, drive coils 34 to be actuated are selected in a fifth method step 105, which is carried out after the third method step 103, on the basis of the position and the position of the movable unit 10. Furthermore, these drive coils 34 to be actuated are energized in a sixth method step 106. In particular, it may be provided that the drive coils 34 of the respective exchange motor module 71 of the respective exchange element 70 that is currently connected to the retraction element 50 are energized. Furthermore, the drive coils 34 of the extension motor module 61 of the extension element 60 that is currently connected to the exchange element 70 may be energized.

In an embodiment of the method for operating the linear transport system 1, position detectors 36 are logically switched over on the basis of the position of the exchange device 41. In particular, it may be provided that the position detectors 36 of the respective exchange motor module 71 of the respective exchange element 70 that is currently connected to the retraction element 50 are used. Furthermore, the position detectors 36 of the extension motor module 61 of the extension element 60 that is currently connected to the exchange element 70 may be used. In particular, the logical switching of the position detectors 36 may involve the position detectors 36 being switched logically in the first position from the retraction motor module 51 via the exchange motor module 71 of the first exchange element 73 to the extension motor module 61 of the first extension element 63 and in the second position from the retraction motor module 51 via the exchange motor module 71 of the second exchange element 74 to the extension motor module 61 of the second extension element 64. In this way, a continuous position detection of the movable unit 10 may be achieved when passing through the switch 40.

In the first position of the exchange device 41, it may be provided that the position detectors 36 of the exchange motor module 71 of the second exchange element 74 are deactivated. In the second position of the exchange device 41, it may be provided that the position detectors 36 of the exchange motor module 71 of the first exchange element 73 are deactivated. Alternatively, however, provision may also be made to leave these position detectors 36 activated, for example when movable units 10 are arranged on the first exchange element 73 or on the second exchange element 74. As a result, for example, movable units 10 may be arranged on the exchange element 70 (i.e. on the first exchange element 73 or the second exchange element 74) that is no longer connected to the retraction element 50 and/or the first extension element 63 or the second extension element 64. However, the associated position detectors 36 may remain activated in order to be able to control the holding and/or positioning of the movable unit 10 at such an exchange element 70.

In an embodiment of the method for operating the linear transport system 1, it is checked whether the exchange device 41 is in the first position or in the second position or in an intermediate position. An intermediate position may be a position in which the exchange device 41 is being moved from the first position to the second position. In the first position, energizing of the drive coils 34 of the exchange motor module 71 of the second exchange element 74 and of the extension motor module 61 of the second extension element 64 is prevented. Alternatively, the drive coils 34 of the exchange motor module 71 of the second exchange element 74 and of the extension motor module 61 of the second extension element 64 may be energized in such a way that a rotor 10 possibly located on the respective motor modules 33 is held in its position but is not driven in a direction for movement. In the second position, energizing of the drive coils 34 of the exchange motor module 71 of the first exchange element 73 and of the extension motor module 61 of the first extension element 63 is prevented. Alternatively, the drive coils 34 of the exchange motor module 71 of the first exchange element 73 and of the extension motor module 61 of the first extension element 63 may be energized in such a way that any rotor 10 located on the respective motor modules 33 is held in its position, but is not driven in a direction for movement. In the intermediate position, energizing of the drive coils 34 of the retraction motor module 51 of the retraction element 50, the exchange motor module 71 of the first exchange element 73, the extension motor module 61 of the first extension element 63, the exchange motor module 71 of the second exchange element 74 and the extension motor module 61 of the second extension element 64 is prevented. Alternatively, the drive coils 34 of the retraction motor module 51 of the retraction element 50, the exchange motor module 71 of the first exchange element 73, the extension motor module 61 of the first extension element 63, the exchange motor module 71 of the second exchange element 74 and the extension motor module 61 of the second extension element 64 may be energized in such a way that any rotor 10 located on the respective motor modules 33 is held in its position but is not driven in a direction of travel. If the third exchange module 75, the fourth exchange module 76 and the fifth exchange module 77 as well as the third extension element 65, the fourth extension element 66 and the fifth extension element 67 are also arranged in the switch, the drive coils 34 of the respective motor modules 33 may also be prevented from being energized depending on the position or the intermediate position. Here too, in an alternative embodiment, the drive coils 34 of the respective motor modules 33 may be energized in such a way that any rotor 10 located on the respective motor modules 33 is held in its position, but is not driven in a direction of travel.

The controller 5 may be set up in each case to carry out the method and may be connected to one motor module 33 or a plurality of motor modules 33 for this purpose. The controller 5 may be set up to issue corresponding control commands to the motor modules 33.

In an embodiment of the linear transport system 1, the linear transport system also comprises a controller 5. The controller 5 is set up to select a control program on the basis of a position of the exchange device 41 and to carry out a logical switching of drive coils 34 on the basis of the position of the exchange device 41. In particular, the controller 5 may also be set up to carry out the method according to the invention. In addition, it may be provided that the controller 5 generally controls all motor modules 33 or all drive coils 34 of the motor modules 33.

In an embodiment of the linear transport system 1, the controller 5 is set up to determine a position of the movable unit 10 with the aid of position detectors 36 arranged within the motor modules 33 and to select the drive coils 34 to be actuated for driving the movable unit 10 on the basis of the position of the movable unit 10 and a position of the exchange device 41 and to initiate energization of these drive coils 34 to be actuated.

In an embodiment example of the linear transport system 1, the controller 5 is also set up to carry out a logical switching of position detectors 36 on the basis of the position of the exchange device 41. In particular, the logical switching of the position detectors 36 may involve the position detectors 36 being switched logically in the first position from the retraction motor module 51 via the exchange motor module 71 of the first exchange element 73 to the extension motor module 61 of the first extension element 63 and in the second position from the retraction motor module 51 via the exchange motor module 71 of the second exchange element 74 to the extension motor module 61 of the second extension element 64. In this way, continuous position detection of the movable unit 10 may be achieved when passing through the switch 40.

In the first position of the exchange device 41, it may be provided that the position detectors 36 of the exchange motor module 71 of the second exchange element 74 are deactivated. In the second position of the exchange device 41, it may be provided that the position detectors 36 of the exchange motor module 71 of the first exchange element 73 are deactivated. Alternatively, however, provision may also be made to leave these position detectors 36 activated, for example when movable units 10 are arranged on the first exchange element 73 or on the second exchange element 74. As a result, for example, movable units 10 may be arranged on that exchange element 70 (i.e. on the first exchange element 73 or on the second exchange element 74) which are no longer connected to the retraction element 50 and/or the first extension element 63 or the second extension element 64. However, in order to be able to control holding and/or positioning of the movable unit 10 at such an exchange element 70, the associated position detectors 36 may remain activated.

In an embodiment of the linear transport system 1, the controller 5 is set up to check whether the exchange device 41 is in the first position or in the second position or in an intermediate position. The controller 5 is further set up to prevent energizing of the drive coils 34 of the exchange motor module 71 of the second exchange element 74 and of the extension motor module 61 of the second extension element 64 in the first position or, alternatively, to energize the drive coils 34 in such a way that a rotor 10 is held in its position but is not moved away. In the second position, the controller 5 is furthermore set up to prevent energizing of the drive coils 34 of the exchange motor module 71 of the first exchange element 73 and of the extension motor module 61 of the first extension element 63 or, alternatively, to energize the drive coils 34 in such a way that a rotor 10 is held in its position but is not moved away. In the intermediate position, the controller 5 is also set up to prevent the drive coils 34 of the retraction motor module 51 of the retraction element 50, the exchange motor module 71 of the first exchange element 73, the extension motor module 61 of the first extension element 63, the exchange motor module 71 of the second exchange element 74 and the extension motor module 61 of the second extension element 64 from being energized or, alternatively, to energize the drive coils 34 in such a way that a rotor 10 is held in its position but not moved away. In this way, safe operation of the linear transport system 1 may be achieved.

This invention has been described with respect to exemplary embodiments. It is understood that changes can be made and equivalents can be substituted to adapt these disclosures to different materials and situations, while remaining with the scope of the invention. The invention is thus not limited to the particular examples that are disclosed, but encompasses all the embodiments that fall within the scope of the claims.

TABLE 1
List of reference numerals

1 Linear transport system
2 Guide rail
3 First area
4 Second area
5 Controller
6 Rolling surface
10 Movable unit
11 Roll
12 Position element
30 Linear motor
31 Stator
32 Rotor
33 Motor module
34 Drive coil
35 Magnet
36 Position detector
37 Stator tooth
40 Switch
41 Exchange device
42 Further switch
43 Further exchange device
44 Movable switch element
45 Displaceable plate
46 Drive
47 Rotatable body
48 Rail
49 Recess
50 Retraction element
51 Retraction motor module
52 Retraction rail element
53 First retraction element
54 Second retraction element
55 Linear drive
56 Rotational drive
57 Transmission
60 Extension element
61 Extension motor module
62 Extension rail element
63 First extension element
64 Second extension element
65 Third extension element
66 Fourth extension element
67 Fifth extension element
70 Exchange element
71 Exchange motor module
72 Exchange rail element
73 First exchange element
74 Second exchange element
75 Third exchange element
76 Fourth exchange element
77 Fifth exchange element
81 First fastening plate
82 Second fastening plate
83 Third fastening plate
84 Recess
85 Supporting element
86 Drive fastening plate
87 Offset structure
100 Flow chart
101 First method step
102 Second method step
103 Third method step
104 Fourth method step
105 Fifth method step
106 Sixth method step

What is claimed is:

1. A linear transport system comprising:
a movable unit,
a guide rail configured for guiding the movable unit, and
a linear motor configured for driving the movable unit along the guide rail;
wherein the linear motor comprises a stator and a rotor,
wherein the stator comprises a plurality of motor modules arranged in a stationary manner along the guide rail, each comprising a plurality of drive coils,
wherein the rotor is arranged on the movable unit and comprises a plurality of magnets, and
wherein the guide rail is arranged on the motor modules;
the linear transport system further comprising at least one switch, wherein the switch comprises:
at least one static retraction element with a retraction motor module and a retraction rail element belonging to the guide rail,
at least two static extension elements, each having an extension motor module and an extension rail element belonging to the guide rail, and
an exchange device, wherein the exchange device comprises at least two exchange elements, each having an exchange motor module and an exchange rail element belonging to the guide rail;
wherein, in a first position of the exchange device, the retraction element is connected to a first extension element via a first exchange element, and
in a second position of the exchange device, the retraction element is connected to a second extension element via a second exchange element.

2. The linear transport system according to claim 1, wherein:
the exchange device comprises more than two exchange elements, each having an exchange motor module and a respective exchange rail element belonging to the guide rail, and
wherein the switch comprises a number of static extension elements adapted to the number of exchange elements, each having an extension motor module and a respective extension rail element belonging to the guide rail.

3. The linear transport system according to claim 1, wherein at least one exchange element is curved.

4. The linear transport system according to claim 1, wherein:
the linear transport system comprises a primary plane, wherein the primary plane is spanned by the retraction motor module and the retraction rail element,
wherein a first extension plane is perpendicular with regard to the primary plane and is guided by the extension rail element of the first extension element, and
wherein the extension rail element of the second extension element also lies in the first extension plane.

5. The linear transport system according to claim 1, wherein:
the linear transport system comprises a primary plane, wherein the primary plane is spanned by the retraction motor module and the retraction rail element,
wherein a first extension plane is perpendicular with regard to the primary plane and is guided by the extension rail element of the first extension element,
wherein the extension rail element of the second extension element lies at least partially in a second extension plane, and
wherein the second extension plane is in parallel to the first extension plane and is arranged at a distance from the first extension plane.

6. The linear transport system according to claim 1, wherein the exchange device comprises a drive, wherein the exchange device is configured to be brought into the first position and into the second position with aid of the drive.

7. The linear transport system according to claim 6, wherein the first exchange element and the second exchange element are arranged on a rotatable body, wherein rotation of the rotatable body is triggerable with aid of the drive.

8. The linear transport system according to claim 6, wherein the first exchange element and the second exchange element are arranged on a displaceable plate, wherein a displacement of the displaceable plate is triggerable with aid of the drive.

9. The linear transport system according to claim 1, wherein:
in the first position of the exchange device, the retraction motor module is flush with the exchange motor module of the first exchange element and the exchange motor module of the first exchange element is flush with the extension motor module of the first extension element, and
in the second position of eh exchange device, the retraction motor module is flush with the exchange motor module of the second exchange element and the exchange motor module of the second exchange element is flush with the extension motor module of the second extension element.

10. The linear transport system according to claim 1, wherein in the first position of the exchange device, a retraction gap with a predetermined retraction gap width is arranged between the retraction motor module and the exchange motor module of the first exchange element.

11. The linear transport system according to claim 1, wherein in the first position of the exchange device, an extension gap with a predetermined extension gap width is arranged between the exchange motor module of the first exchange element and the extension motor module of the first extension element.

12. The linear transport system according to claim 1, wherein:
the drive coils are arranged within the motor modules such that two drive coils have a predetermined distance, and
wherein a drive coil arranged at a rear in a direction of travel in the retraction motor module and a drive coil arranged at a front in the direction of travel in the exchange motor module of the first exchange element also have the predetermined distance, when the exchange device is arranged in the first position, and
the drive coil arranged at the rear in the direction of travel in the retracting motor module and a drive coil arranged at a front in the direction of travel in the exchange motor module of the second exchange element also have the predetermined distance, when the exchange device is arranged in the second position.

13. The linear transport system according to claim 1, further comprising:
a controller,
wherein the controller is configured to select a control program on the basis of a position of the exchange device, and to carry out a logical switching of drive coils on the basis of the position of the exchange device.

14. The linear transport system according to claim 13, wherein the controller configured to:
determine a position of the movable unit on the basis of position detectors arranged within the motor modules, and to select the drive coils to be actuated for driving the movable unit on the basis of the position of the movable unit and the position of the exchange device, and
to initiate energization of these drive coils to be actuated, wherein the controller is further configured to carry out a logical switching of position detectors on the basis of the position of the exchange device.

15. The linear transport system according to claim 13, wherein:
the controller is configured to check whether the exchange device is in the first position or in the second position, or in an intermediate position,
wherein the controller is configured to prevent energizing of the drive coils of the exchange motor module of the second exchange element and of the extension motor module of the second extension element, when the exchange device is arranged in the first position,
wherein the controller is configured to prevent energizing of the drive coils of the exchange motor module of the first exchange element and of the extension motor module of the second extension element, when the exchange device is arranged in the second position, and
wherein the controller is configured to prevent energizing of the drive coils of the retraction motor module of the retraction element, of the exchange motor module of the first exchange element, of the extension motor module of the first extension element, of the exchange motor module of the second exchange element and of the extension motor module of the second extension element, when the exchange device is arranged in the intermediate position.

16. A method for operating a linear transport system, the linear transport system comprising:
a movable unit,
a guide rail configured for guiding the movable unit, and
a linear motor configured for driving the movable unit along the guide rail;
wherein the linear motor comprises a stator and a rotor,
wherein the stator comprises a plurality of motor modules arranged in a stationary manner along the guide rail, each comprising a plurality of drive coils,
wherein the rotor is arranged on the movable unit and comprises a plurality of magnets, and
wherein the guide rail is arranged on the motor modules;
the linear transport system further comprising at least one switch, wherein the switch comprises:
at least one static retraction element with a retraction motor module and a retraction rail element belonging to the guide rail,
at least two static extension elements, each having an extension motor module and an extension rail element belonging to the guide rail, and
an exchange device, wherein the exchange device comprises at least two exchange elements, each having an exchange motor module and an exchange rail element belonging to the guide rail;
wherein, in a first position of the exchange device, the retraction element is connected to a first extension element via a first exchange element, and,
in a second position of the exchange device, the retraction element is connected to a second extension element via a second exchange element,
the method comprising steps of:
determining a position of an exchange device of the linear transport system;
selecting a control program based on the position of the exchange device; and
logically switching drive coils of the linear transport system based on the position of eh exchange device.

17. The method according to claim 16, further comprising additional steps of:
determining a position of the movable unit with aid of position detectors arranged within the motor modules;
selecting drive coils to be actuated on the basis of the position of the exchange device and the position of the moving unit; and
energizing the drive coils to be actuated.

18. The method according to claim 17, wherein a logical switching of the position detectors takes place on the basis of the position of the exchange device.

19. The method according to claim 18, further comprising:
checking whether the exchange device is in the first position or in the second position, or in an intermediate position,
wherein energizing of the drive coils of the exchange motor module of the second exchange element and of the extension motor module of the second extension element is prevented, when the exchange device is arranged in the first position,
wherein energizing energization of the drive coils of the exchange motor module of the first exchange element and of the extension motor module of the first extension element is prevented, when the exchange device is arranged in the second position, and
wherein energizing of the drive coils of the retraction motor module of the retraction element, of the exchange motor module of the first exchange element, of the extension motor module of the first extension element, of the exchange motor module of the second exchange element and of the extension motor module of the second extension element is prevented, when the exchange device is arranged in the intermediate position.

20. A switch for a linear transport system, comprising:
at least one static retraction element having a retraction motor module and a retraction rail element belonging to the guide rail,
at least two static extension elements having in each case one extension motor module and in each case one extension rail element belonging to the guide rail, and
an exchange device, wherein the exchange device comprises at least three exchange elements, each having an exchange motor module and a respective exchange rail element belonging to the guide rail; and
at least one static retraction element with a retraction motor module and a retraction rail element belonging to the guide rail,
at least two static extension elements, each having an extension motor module and an extension rail element belonging to the guide rail, and
an exchange device;
wherein in a first position of the exchange device the retraction element is connected to a first extension element via a first exchange element,
wherein in a second position of the exchange device the retraction element is connected to a second extension element via a second exchange element, and
wherein in a third position of the exchange device the retraction element is connected to a third extension element via a third exchange element.
